(19) United States
(12) Patent Application Publication
(10) Pub. No.: US 2026/0323090 A1
(43) Pub. Date: Oct. 15, 2026

(54) METHOD FOR ENCODING, DECODING, TRAINING AND RELATED DEVICE

(71) Applicant: HUAWEI TECHNOLOGIES CO., LTD., Shenzhen (CN)

(72) Inventors: Georgii Petrovich Gaikov, Moscow (RU); Sergey Yurievich Ikonin, Moscow (RU); Ivan Leonidovich Mazurenko, Moscow (RU); Alina AFRAKOVA, Moscow (RU); Pavel LUKIANOV, Moscow (RU)

(73) Assignee: HUAWEI TECHNOLOGIES CO., LTD., Shenzhen (CN)

(21) Appl. No.: 19/704,862

(22) Filed: Jun. 11, 2026

Related U.S. Application Data
(63) Continuation of application No. PCT/RU2023/000384, filed on Dec. 12, 2023.

(51) Int. Cl. H04N 19/60; H04N 19/136; H04N 19/436; H04N 19/463; H04N 19/91

(52) U.S. Cl. CPC H04N 19/60; H04N 19/136; H04N 19/436; H04N 19/463; H04N 19/91

(57) ABSTRACT

Embodiments of the present application provide a method for coding, a method for decoding, a method for training, and related devices. The decoding method may include acquiring a bitstream D₀; determining a reconstructed feature tensor \hat{z}₀ according to the bitstream D₀; performing a decoding operation on the reconstructed feature tensor \hat{z}₀ to obtain a reconstructed latent representation ŷ₀ by using a neural network; performing a synthesis transform operation based on the reconstructed latent representation ŷ₀ to generate a reconstructed signal \hat{x}. Based on the method provided by the embodiments of the present application, different features of input data are compressed to different number of bits.

### CROSS-REFERENCE TO RELATED APPLICATIONS

This application is a continuation of International Application No. PCT/RU2023/000384, filed on Dec. 12, 2023, the disclosure of which is hereby incorporated by reference in its entirety.

### TECHNICAL FIELD

Embodiments of the present application relate to the field of signal processing technologies, and more specifically, to a method for encoding, a method for decoding, a method for training, and related devices.

### BACKGROUND

With the exponential growth of data, the demand for bandwidth and storage space has become a significant concern. For example, video data typically consists of numerous consecutive frames, each comprising millions of pixels. Consequently, processing and transmitting video data require substantial bandwidth and storage capacity. Similarly, image data can also be sizable, especially in the case of high-resolution images. These datasets necessitate considerable bandwidth for transmission and occupy significant storage space. One solution to address this challenge is through data compression techniques. By compressing the data, it becomes possible to reduce the required bandwidth for transmission and save storage space.

In the field of data compression, encoding plays a crucial role, and one commonly used method is entropy-based coding. However, the efficiency of entropy-based coding is not very high. Therefore, improving encoding efficiency is an important problem that needs to be addressed.

### SUMMARY

Embodiments of the present application provide a method for encoding, a method for decoding, a method for training, and related devices. Based on the method provided by the embodiments of the present application, different features of input data are compressed to different number of bits.

According to a first aspect, an embodiment of the present application provides a decoding method. The method may include acquiring a bitstream D₀. The method may include determining a reconstructed feature tensor \hat{z}₀ according to the bitstream D₀. The method may include performing a decoding operation on the reconstructed feature tensor \hat{z}₀ to obtain a reconstructed latent representation ŷ₀ by using a neural network. The method may include performing a synthesis transform operation based on the reconstructed latent representation ŷ₀ to generate a reconstructed signal \hat{x}.

The present application provides a neural network (NN) based video, image, audio codecs—source codecs (which are focused only on data compression), channel codecs ((which are focused only on data transmission) and joint source channel coding (which are focused both on data compression and transmission). The NN is used to encode and decode the input data into bitstream. Different features of the input data are compressed to different number of bits (‘words’). The NN may learn their own encoding/decoding way of latent space features represented as floats or integers to binary representation for sending via communication channel, find some correlations, and use less bits to encode data. Further, the ENC NN and the DEC NN may be end to end train together with noise—simulating both bit errors and packet losses—thus, becoming tolerant to errors, distortions and losses in communication channel.

Compared with conventional entropy encoding solutions, the NN based encoding solution provided by the present application have less complexity and less encoding/decoding time due to massive parallel processing on NN supporting hardware. Finally, the present application works in digital domain and do not making any constrains to physical layer having friendly design to existing widely deployed digital communication infrastructure. Therefore, the present application may be deployed with existing hardware (such as routers, Wi-Fi access points, 3G/4G/5G wireless communication devices).

In some embodiments, the decoding operation may be a decoding operation that is able to pass a loss gradient.

In an embodiment, the method further includes: acquiring a decoding information, the determining a reconstructed feature tensor \hat{z}₀ according to the bitstream D₀, includes: determining the reconstructed feature tensor \hat{z}₀ according to the decoding information and the bitstream D₀, wherein a size of the reconstructed feature tensor \hat{z}₀ is larger than a size of the bitstream D₀.

In an embodiment, the decoding information is obtained based on information signaled with the bitstream D₀.

In an embodiment, the decoding information includes a length tensor N_{bits0}.

In an embodiment, the determining the reconstructed feature tensor \hat{z}₀ according to the decoding information, includes: determining a mask tensor MSK₀ according to the length tensor N_{bits0} and an index tensor idx₀, wherein the bitstream D₀ includes X₁ bit(s), the mask tensor MSK₀ includes X₁ first element(s) with a first value and X₂ second element(s) with a second value, X₁, a sum of X₁ and X₂ is the size of the reconstructed feature tensor \hat{z}₀, X₁ is a positive integer, X₂ is a positive integer; determining the reconstructed feature tensor \hat{z}₀ according to the mask tensor MSK₀ and the bitstream D₀, wherein the reconstructed feature tensor \hat{z}₀ includes X₁ third element(s) and X₂ fourth element(s), a location of each element in the reconstructed feature tensor \hat{z}₀ is a same as a location of a corresponding element in the mask tensor MSK₀, a value of each of the X₁ third element(s) is a same as a value of a corresponding bit in the bitstream D₀, and a value of each of the X₂ fourth element(s) is a preset value that is not equals to 1.

In an embodiment, the method further includes: acquiring M bitstream(s), wherein M is a positive integer; determining M reconstructed feature tensor(s) according to the M bitstream(s) respectively; performing M decoding operation(s) on the M reconstructed feature tensor(s) to obtain M reconstructed latent representation(s); the performing a synthesis transform operation based on the reconstructed latent representation ŷ₀ to generate a reconstructed signal \hat{x}, includes: performing the synthesis transform operation based on the reconstructed latent representation y̅₀ and the M reconstructed latent representation(s) to generate the reconstructed signal \hat{x}.

In an embodiment, the performing the synthesis transform operation based on the reconstructed latent representation ŷ₀ and the M reconstructed latent representation(s) to generate the reconstructed signal \hat{x}, includes: performing the synthesis transform operation on each of the reconstructed latent representation ŷ₀ and the M reconstructed latent representation(s) to obtain M+1 synthesis transform results; generating the reconstructed signal \hat{x} according to the M+1 synthesis transformation results.

In an embodiment, the performing the synthesis transform operation base on the reconstructed latent representation ŷ₀ and the M reconstructed latent representation(s) to generate the reconstructed signal \hat{x}, includes: determining a reference reconstructed latent representation, wherein the reference reconstructed latent representation is a sum of the reconstructed latent representation ŷ₀ and the M reconstructed latent representation(s); performing the synthesis transform operation on the reference reconstructed latent representation to generate the reconstructed signal \hat{x}.

In an embodiment, the performing the synthesis transform operation based on the reconstructed latent representation ŷ₀ and the M reconstructed latent representation(s) to generate the reconstructed signal \hat{x}, includes: performing M+1 synthesis transform operations on M+1 reference information to generate the reconstructed signal \hat{x}, wherein a first reference information among the M+1 reference information is the reconstructed latent representation ŷ₀, a m+1^{th} reference information is determined according to a m^{th} transformed information and a m^{th} reconstructed latent representation, the m^{th} transformed information is determined according to a synthesis transformation result of a m^{th} synthesis transform operation among the M+1 synthesis transform operations.

In an embodiment, the method further includes: performing a variation operation on a reference reconstructed latent representation, wherein the reference reconstructed latent representation is a reconstructed latent representation determined by a reference decoding operation, the reference decoding operation is the decoding operation or one of the M decoding operation(s), the variation operation includes at least one of the followings: a sampling variation operation, or, a linear transformation, or an analysis transform operation, and the reconstructed signal \hat{x} is determined according to the varied reconstructed latent representation.

In an embodiment, the acquiring a bitstream D₀, includes: performing an entropy decoding operation on a received bitstream to obtain the bitstream D₀.

In an embodiment, the method further includes: obtaining an optimized parameter; the performing an entropy decoding operation on a received bitstream to obtain the bitstream D₀, includes: performing, according to the optimized parameter, the entropy decoding operation on the received bitstream to obtain the bitstream D₀.

According to a second aspect, an embodiment of the present application provides an encoding method. The method may include acquiring an input signal. The method may include performing an analysis transform operation based on the input signal to obtain a latent representation y₀. The method may include performing an encoding operation based on the latent representation ŷ₀ to obtain a feature tensor z₀ by using a neural network; generating a bitstream D₀ according to the feature tensor z₀.

The present application provides a neural network (NN) based video, image, audio codecs—source codecs (which are focused only on data compression), channel codecs ((which are focused only on data transmission) and joint source channel coding (which are focused both on data compression and transmission). The NN is used to encode and decode the input data into bitstream. Different features of the input data are compressed to different number of bits (‘words’). The NN may learn their own encoding/decoding way of latent space features represented as floats or integers to binary representation for sending via communication channel, find some correlations, and use less bits to encode data. Further, the ENC NN and the DEC NN may be end to end train together with noise—simulating both bit errors and packet losses—thus, becoming tolerant to errors, distortions and losses in communication channel.

Compared with conventional entropy encoding solutions, the NN based encoding solution provided by the present application have less complexity and less encoding/decoding time due to massive parallel processing on NN supporting hardware. Finally, the present application works in digital domain and do not making any constrains to physical layer having friendly design to existing widely deployed digital communication infrastructure. Therefore, the present application may be deployed with existing hardware (such as routers, Wi-Fi access points, 3G/4G/5G wireless communication devices).

In some embodiments, the encoding operation may be a decoding operation that is able to pass a loss gradient.

In an embodiment, the method further includes: acquiring an encoding information; the generating a bitstream D₀ according to the feature tensor z₀, includes: generating the bitstream D₀ according to the encoding information and the feature tensor z₀, wherein a size of the feature tensor z₀ is larger than a size of the bitstream D₀.

In an embodiment, the encoding information is signaled with the bitstream DO.

In an embodiment, the encoding information is a length tensor N_{bits0}.

In an embodiment, the length tensor N_{bist0} is obtained by the encoding operation using the neural network.

In an embodiment, the generating the bitstream D₀ according to the encoding information and the feature tensor z₀, includes: determining a mask tensor MSK₀ according to the length tensor N_{bits0} and an index tensor idx₀, wherein the mask tensor MSK₀ includes X₁ first element(s) with a first value and X₂ second element(s) with a second value, a sum of X₁ and X₂ is the size of the feature tensor z₀, X₁ is a positive integer, X₂ is a positive integer; determining the bitstream D₀ according to the mask tensor MSK₀ and the feature tensor z₀, wherein the bitstream Do includes X₁ bit(s), the feature tensor z₀ includes X₁ third element(s) and X₂ fourth element(s), a location of each elements in the feature tensor z₀ is a same of a location of a corresponding element in the mask tensor MSK₀, a value of each of the X₁ third element(s) is configured to obtain a value of a corresponding bit in the bitstream D₀.

In an embodiment, the method further includes: performing M encoding operation(s) and M decoding operation(s) according to the bitstream D₀ to obtain M bitstream(s), wherein a m^{th} bitstream among the M bitstream(s) is generated by performing a m^{th} encoding operation among the M encoding operation(s) on an input data INPₘ, and the input data INPₘ is determined according to m reconstructed latent representation(s) obtained according to a first m−1 decoding operation(s) of the M decoding operation(s), m=1, . . . , M.

In an embodiment, the input data INPₘ and the m reconstructed latent representation(s) satisfy:

$${INP}_{m} = AT ( x - {\sum }_{i = 1}^{m} ST ( {\hat{y}}_{i} ) )$$

wherein INPₘ is the input data INPₘ, AT( ) denotes the analysis transform operation, ST( ) denotes a synthesis transform operation, x is the input signal, and ŷᵢ is an i^{th} reconstructed latent representation among the m reconstructed latent representation(s).

In an embodiment, the input data INPₘ and the m reconstructed latent representation(s) satisfy:

$${INP}_{𝔪} = {y}_{0} - {\sum }_{i = 1}^{𝔪} {\hat{y}}_{i}$$

wherein INPₘ is the input data INPₘ, y₀ is the latent representation ŷ₀, and ŷᵢ is an i^{th} reconstructed latent representation among the m reconstructed latent representation(s).

In an embodiment, the input data INPₘ and the m reconstructed latent representation(s) satisfy:

INPₘ=AT_{K-m}−STₘ,

wherein INPₘ is the input data INPₘ, AT_{K-m} is a result of a (K−m)^{th} analysis transform operation among K analysis transform operation(s); STₘ is a result of a m^{th} synthesis transform operation among K synthesis transform operation(s), and the m^{th} synthesis transform operation is performed on a target data determined according to the m reconstructed latent representation(s).

In an embodiment, the method further includes: performing a first variation operation on a reference input data, wherein the reference input data is an input data of a reference encoding operation, the reference encoding operation is the encoding operation or one of the M encoding operation(s), the first variation operation includes at least one of the followings: a sampling variation operation, or, a linear transformation, or an analysis transform operation, and the reference encoding operation is performed on the varied first input data; performing a second variation operation on a result of a reference decoding operation, wherein the second variation operation is a variation operation corresponding to the first the variation operation.

In an embodiment, the method further includes: performing an entropy coding operation on the bitstream D₀.

In an embodiment, the performing an entropy coding operation on the encoded bitstream D₀, includes: determining an optimized parameter according to the bitstream D₀ by an optimization model; performing, according to the optimized parameter, the entropy coding operation on the bitstream D₀.

According to a third aspect, an embodiment of the present application provides a method for training a neural network. The method may include including: acquiring an input signal x. The method may include performing an analysis transform operation based on the input signal to obtain a latent representation y₀. The method may include performing an encoding operation based on the latent representation y₀ to obtain a feature tensor z₀ containing values in the range of 0 to 1 by using a first neural network. The method may include obtaining a reconstructed feature tensor \hat{z}₀ based on the feature tensor z₀. The method may include performing a decoding operation on the reconstructed feature tensor \hat{z}₀ to obtain a reconstructed latent representation ŷ₀ by using a second neural network. The method may include performing a synthesis transform operation based on the reconstructed latent representation ŷ₀ to generate a reconstructed signal \hat{x}. The method may include determining a loss function value according to the input signal x and the reconstructed signal \hat{x}. The method may include determining a first target neural network according to the first neural network and the loss function value. The method may include determining a second target neural network according to the second neural network and the loss function value.

The present application provides a neural network (NN) based video, image, audio codecs—source codecs (which are focused only on data compression), channel codecs ((which are focused only on data transmission) and joint source channel coding (which are focused both on data compression and transmission). The NN is used to encode and decode the input data into bitstream. Different features of the input data are compressed to different number of bits (‘words’). The NN may learn their own encoding/decoding way of latent space features represented as floats or integers to binary representation for sending via communication channel, find some correlations, and use less bits to encode data. Further, the ENC NN and the DEC NN may be end to end train together with noise—simulating both bit errors and packet losses—thus, becoming tolerant to errors, distortions and losses in communication channel.

Compared with conventional entropy encoding solutions, the NN based encoding solution provided by the present application have less complexity and less encoding/decoding time due to massive parallel processing on NN supporting hardware. Finally, the present application works in digital domain and do not making any constrains to physical layer having friendly design to existing widely deployed digital communication infrastructure. Therefore, the present application may be deployed with existing hardware (such as routers, Wi-Fi access points, 3G/4G/5G wireless communication devices).

In an embodiment, the obtaining a reconstructed feature tensor \hat{z}₀ based on the feature tensor z₀ includes: assigning the reconstructed feature tensor \hat{z}₀ equal to the feature tensor z₀.

In an embodiment, the obtaining a reconstructed feature tensor \hat{z}₀ based on the feature tensor z₀ includes: distorting at least one element of the feature tensor z₀ to obtain the reconstructed feature tensor \hat{z}₀.

According to the above-mentioned technical solution, the present application allows to get trainable error tolerant data coding, or NN based data encryption system. The most obvious applications may include real time communication and video streaming systems, such as online meetings and video transmission, such as from phone to TV, from computer to projector, from drone to VR glasses and so on.

In an embodiment, the distorting at least one element of the feature tensor z₀ includes inverting 0 to 1 and 1 to 0.

According to a fourth aspect, an embodiment of the present application provides an electronic device, and the electronic device has a function of implementing the method in the first aspect. The function may be implemented by hardware, or may be implemented by hardware executing corresponding software. The hardware of the software includes one or more units corresponding to the function.

According to a fifth aspect, an embodiment of the present application provides an electronic device, and the electronic device has a function of implementing the method in the second aspect. The function may be implemented by hardware, or may be implemented by hardware executing corresponding software. The hardware of the software includes one or more units corresponding to the function.

According to a sixth aspect, an embodiment of the present application provides an electronic device, and the electronic device has a function of implementing the method in the third aspect. The function may be implemented by hardware, or may be implemented by hardware executing corresponding software. The hardware of the software includes one or more units corresponding to the function.

According to a seventh aspect, an embodiment of the present application provides a computer readable storage medium including instructions. When the instructions run on an electronic device, the electronic device is enabled to perform the method in the first aspect or any possible implementation of the first aspect.

According to an eighth aspect, an embodiment of the present application provides a computer readable storage medium including instructions. When the instructions run on an electronic device, the electronic device is enabled to perform the method in the second aspect or any possible implementation of the second aspect.

According to a ninth aspect, an embodiment of the present application provides a computer readable storage medium including instructions. When the instructions run on an electronic device, the electronic device is enabled to perform the method in the third aspect or any possible implementation of the third aspect.

According to a tenth aspect, an embodiment of the present application provides an electronic device, including a processor and a memory. The processor is connected to the memory. The memory is configured to store instructions, and the processor is configured to execute the instructions. When the processor executes the instructions stored in the memory, the processor is enabled to perform the method in the first aspect or any possible implementation of the first aspect.

According to an eleventh aspect, an embodiment of the present application provides an electronic device, including a processor and a memory. The processor is connected to the memory. The memory is configured to store instructions, and the processor is configured to execute the instructions. When the processor executes the instructions stored in the memory, the processor is enabled to perform the method in the second aspect or any possible implementation of the second aspect.

According to a twelfth aspect, an embodiment of the present application provides an electronic device, including a processor and a memory. The processor is connected to the memory. The memory is configured to store instructions, and the processor is configured to execute the instructions. When the processor executes the instructions stored in the memory, the processor is enabled to perform the method in the third aspect or any possible implementation of the third aspect.

According to a thirteenth aspect, an embodiment of the present application provides a chip system, where the chip system includes a memory and a processor, and the memory is configured to store a computer program, and the processor is configured to invoke the computer program from the memory and run the computer program, so that an electronic device on which the chip system is disposed performs the method in the first aspect or any possible implementation of the first aspect.

According to a fourteenth aspect, an embodiment of the present application provides a chip system, where the chip system includes a memory and a processor, and the memory is configured to store a computer program, and the processor is configured to invoke the computer program from the memory and run the computer program, so that an electronic device on which the chip system is disposed performs the method in the second aspect or any possible implementation of the second aspect.

According to a fifteenth aspect, an embodiment of the present application provides a chip system, where the chip system includes a memory and a processor, and the memory is configured to store a computer program, and the processor is configured to invoke the computer program from the memory and run the computer program, so that an electronic device on which the chip system is disposed performs the method in the third aspect or any possible implementation of the third aspect.

According to a sixteenth aspect, an embodiment of the present application provides a computer program product, where when the computer program product runs on an electronic device, the electronic device is enabled to perform the method in the first aspect or any possible implementation of the first aspect.

According to a seventeenth aspect, an embodiment of the present application provides a computer program product, where when the computer program product runs on an electronic device, the electronic device is enabled to perform the method in the second aspect or any possible implementation of the second aspect.

According to an eighteenth aspect, an embodiment of the present application provides a computer program product, where when the computer program product runs on an electronic device, the electronic device is enabled to perform the method in the third aspect or any possible implementation of the third aspect.

According to a nineteenth aspect, an embodiment of the present application provides computer readable storage medium, where the computer readable storage medium stores a bitstream, the bitstream is obtained by using the method according to the second aspect or any possible implementation of the second aspect.

### DESCRIPTION OF DRAWINGS

FIG. 1 is a schematic block diagram illustrating a coding system according to some embodiments of the present application.

FIG. 2 illustrates a network architecture of a compression network.

FIG. 3 illustrates a network architecture of a compression network in accordance with some embodiments of the present application.

FIG. 4 illustrates an encoding method according to some embodiments of the present application.

FIG. 5 illustrates an encoding method according to some embodiments of the present application.

FIG. 6 illustrates another encoding method according to some embodiments of the present application.

FIG. 7 illustrates an encoding method according some embodiments of the present application.

FIG. 8 illustrates an encoding-decoding procedure according to some embodiments of the present application.

FIG. 9 illustrates an encoding-decoding procedure according to some embodiments of the present application.

FIG. 10 illustrates a decoding method according to some embodiments of the present application.

FIG. 11 illustrates a decoding procedure according to some embodiments of the present application.

FIG. 12 illustrates 5 DECs and 5 synthesis transform operations.

FIG. 13 illustrates an encoding procedure and a corresponding decoding procedure according to some embodiments of the present application.

FIG. 14 illustrates an encoding procedure and a corresponding decoding procedure according to some embodiments of the present application.

FIG. 15 illustrates a system architecture according to some embodiments of the present application.

FIG. 16 illustrates a training method according to some embodiments of the present application.

FIG. 17 is a schematic block diagram of an electronic device according to some embodiments of the present application.

FIG. 18 is a schematic block diagram of an electronic device according to some embodiments of the present application.

FIG. 19 is a schematic block diagram of an electronic device according to some embodiments of the present application.

FIG. 20 is a schematic block diagram of an electronic device according to some embodiments of the present application.

### DESCRIPTION OF EMBODIMENTS

The following describes the technical solutions in the present application with reference to the accompanying drawings.

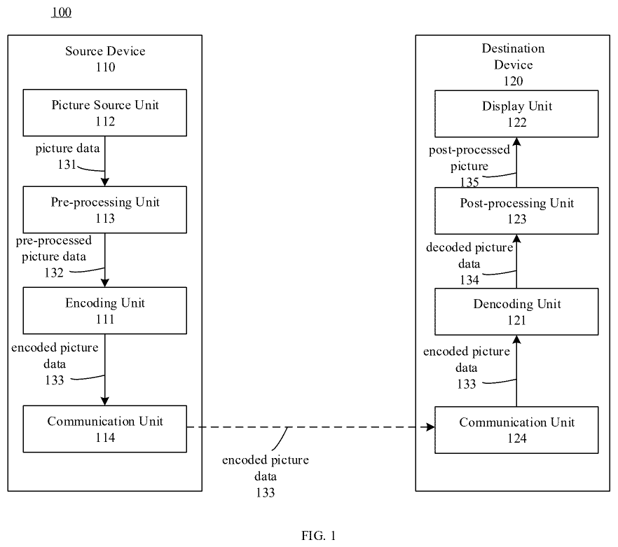

FIG. 1 is a schematic block diagram illustrating a coding system according to some embodiments of the present application. Referring to FIG. 1, the coding system 100 includes a source device 110 configured to provide encoded picture data to a destination device 120 for decoding the encoded picture data. For convenience, it is assumed that the coding system 100 is a picture coding system. As will be apparent for the skilled person, the picture coding system is just example embodiments of the invention and embodiments of the invention are not limited thereto. The source device 110 may include an encoding unit 111. Optionally, the source device 110 may further include a picture source unit 112, a pre-processing unit 113, and a communication unit 114.

The picture source unit 112 may include or be any kind of picture capturing device, for example for capturing a real-word picture, and/or any kind of a picture generating device, for example a computer-graphics processor for generating a computer animated picture, or any kind of device for obtaining and/or providing a real-word picture, a computer animated picture (e.g., a screen content, a virtual reality (VR) picture) and/or any combination thereof (e.g., an augmented reality (AR) picture). In the following, all these kinds of pictures and any other kind of picture will be referred to as “picture”.

A (digital) picture is or can be regarded as a two-dimensional array or matrix of samples with intensity values. A sample in the array may also be referred to as pixel (short form of picture element) or a pel. The number of samples in horizontal and vertical direction (or axis) of the array or picture define the size and/or resolution of the picture. For representation of color, typically three-color components are employed, i.e. the picture may be represented or include three sample arrays. In RBG format or color space a picture comprises a corresponding red, green and blue sample array. However, in video coding each pixel is typically represented in a luminance/chrominance format or color space, e.g. YCbCr, which comprises a luminance component indicated by Y (sometimes also L is used instead) and two chrominance components indicated by Cb and Cr. The luminance (or short luma) component Y represents the brightness or grey level intensity (e.g. like in a grey-scale picture), while the two chrominance (or short chroma) components Cb and Cr represent the chromaticity or color information components. Accordingly, a picture in YCbCr format comprises a luminance sample array of luminance sample values (Y), and two chrominance sample arrays of chrominance values (Cb and Cr). Pictures in RGB format may be converted or transformed into YCbCr format and vice versa, the process is also known as color transformation or conversion. If a picture is monochrome, the picture may comprise only a luminance sample array.

The picture source unit 112 may be, for example a camera for capturing a picture, a memory, e.g. a picture memory, comprising or storing a previously captured or generated picture, and/or any kind of interface (internal or external) to obtain or receive a picture. The camera may be, for example, a local or integrated camera integrated in the source device, the memory may be a local or integrated memory, e.g. integrated in the source device. The interface may be, for example, an external interface to receive a picture from an external video source, for example an external picture capturing device like a camera, an external memory, or an external picture generating device, for example an external computer-graphics processor, computer or server. The interface can be any kind of interface, e.g. a wired or wireless interface, an optical interface, according to any proprietary or standardized interface protocol. The interface for obtaining the picture data 312 may be the same interface as or a part of the Communication unit 114.

In distinction to the pre-processing unit 113 and the processing performed by the pre-processing unit 113, the picture or picture data 131 may also be referred to as raw picture or raw picture data 131.

The pre-processing unit 113 is configured to receive the (raw) picture data 131 and to perform pre-processing on the picture data 131 to obtain a pre-processed picture 132 or pre-processed picture data.

The pre-processing performed by the pre-processing unit 113 may, e.g., comprise trimming, color format conversion (e.g. from RGB to YCbCr), color correction, or de-noising. The encoding unit 111 is configured to receive the pre-processed picture data 132 and provide encoded picture data 133.

The communication unit 114 of the source device 110 may be configured to receive the encoded picture data 133 and to directly transmit it to another device, e.g. the destination device 120 or any other device, for storage or direct reconstruction, or to process the encoded picture data 133 for respectively before storing the encoded picture data 133 and/or transmitting the encoded picture data 133 to another device, e.g. the destination device 120 or any other device for decoding or storing.

The destination device 120 comprises a decoding unit 121, and may additionally, i.e. optionally, comprise a communication unit 124, a post-processing unit 123 and a display unit 122.

The communication unit 124 of the destination device 120 is configured receive the encoded picture data 133, e.g. directly from the source device 110 or from any other source, e.g. a memory, e.g. an encoded picture data memory.

The communication unit 114 and the communication unit 124 may be configured to transmit respectively receive the encoded picture data 133 via a direct communication link between the source device 110 and the destination device 120, e.g. a direct wired or wireless connection, or via any kind of network, e.g. a wired or wireless network or any combination thereof, or any kind of private and public network, or any kind of combination thereof.

The communication unit 114 may be, e.g., configured to package the encoded picture data 133 into an appropriate format, e.g. packets, for transmission over a communication link or communication network, and may further comprise data loss protection and data loss recovery.

The communication unit 124, forming the counterpart of the communication unit 114, may be, e.g., configured to de-package the packets to obtain the encoded picture data 133 and may further be configured to perform data loss protection and data loss recovery, e.g. comprising error concealment.

The communication unit 124, forming the counterpart of the communication unit 114, may further be configured to perform communication without or with limited data loss protection, and without re-transmission of lost or corrupted data to minimize communication delay and end-to-end latency between source and destination device. In such configuration the encoded picture data 133 may contain errors after receiving by communication unit 124. For binary represented signals the communication errors will lead to inverting 0 to 1 and vice versa.

Both, the communication unit 114 and the communication unit 124 may be configured as unidirectional communication interfaces as indicated by the arrow for the encoded picture data 133 in FIG. 1 pointing from the source device 110 to the destination device 120, or bi-directional.

The communication units, and may be configured, e.g. to send and receive messages, e.g. to set up a connection, to acknowledge and/or re-send lost or delayed data including picture data, and exchange any other information related to the communication link and/or data transmission, e.g. encoded picture data transmission.

The decoding unit 121 is configured to receive the encoded picture data 133 and provide decoded picture data 134.

The post-processing unit 123 of destination device 120 is configured to post-process the decoded picture data 134 to obtain post-processed picture data 135. The post-processing performed by the post-processing unit 123 may comprise, e.g. color format conversion (e.g. from YCbCr to RGB), color correction, trimming, or re-sampling, or any other processing, e.g. for preparing the decoded picture data 134 for display, e.g. by display unit 122.

The display unit 122 of the destination device 120 is configured to receive the post-processed picture data 135 for displaying the picture, e.g. to a user or viewer. The display unit 122 may be or comprise any kind of display for representing the reconstructed picture, e.g. an integrated or external display or monitor. The displays may, e.g. comprise cathode ray tubes (CRT), liquid crystal displays (LCD), plasma displays, organic light emitting diodes (OLED) displays or any kind of other display, such as beamer, hologram (3D), or the like.

Although FIG. 1 depicts the source device 110 and the destination device 120 as separate devices, embodiments of devices may also comprise both or both functionalities, the source device 110 or corresponding functionality and the destination device 120 or corresponding functionality. In such embodiments the source device 110 or corresponding functionality and the destination device 120 or corresponding functionality may be implemented using the same hardware and/or software or by separate hardware and/or software or any combination thereof.

As will be apparent for the skilled person based on the description, the existence and (exact) split of functionalities of the different units or functionalities within the source device 110 and/or destination device 120 as shown in FIG. 1 may vary depending on the actual device and application.

Therefore, the source device 110 and the destination device 120 as shown in FIG. 1 are just example embodiments of the invention and embodiments of the invention are not limited to those shown in FIG. 1.

The source device 110 and the destination device 120 may comprise any of a wide range of devices, including any kind of handheld or stationary devices, e.g. notebook or laptop computers, mobile phones, smart phones, tablets or tablet computers, cameras, desktop computers, set-top boxes, televisions, display devices, digital media players, video gaming consoles, video streaming devices, broadcast receiver device, or the like and may use no or any kind of operating system.

The embodiments of this application relate to application of a large quantity of neural networks. Therefore, for ease of understanding, related terms and related concepts such as the neural network in the embodiments of this application are first described below.

### (1) Neural Network

The neural network may include neurons. The neuron may be an operation unit that uses xₛ and an intercept 1 as inputs, and an output of the operation unit may be as follows:

$${h}_{W , b} ( x ) = f ( {W}^{T} x ) = f ( {\sum }_{s = 1}^{n} {W}_{s} {x}_{s} + b )$$

Herein, s=1, 2, . . . , or n, n is a natural number greater than 1, Ws is a weight of xₛ, and b is bias of the neuron. f is an activation function of the neuron, and the activation function is used to introduce a non-linear feature into the neural network, to convert an input signal in the neuron into an output signal. The output signal of the activation function may be used as an input of a next convolutional layer. The activation function may be a sigmoid function. The neural network is a network formed by connecting many single neurons together. To be specific, an output of a neuron may be an input of another neuron. An input of each neuron may be connected to a local receptive field of a previous layer to extract a feature of the local receptive field. The local receptive field may be a region including several neurons.

### (2) Deep Neural Network

The deep neural network (DNN), also referred to as a multi-layer neural network, may be understood as a neural network having many hidden layers. The “many” herein does not have a special measurement standard. The DNN is divided based on locations of different layers, and a neural network in the DNN may be divided into three types: an input layer, a hidden layer, and an output layer. Generally, the first layer is the input layer, the last layer is the output layer, and the middle layer is the hidden layer. Layers are fully connected. To be specific, any neuron at the ith layer is certainly connected to any neuron at the (i+1)th layer. Although the DNN looks to be complex, the DNN is actually not complex in terms of work at each layer, and is simply expressed as the following linear relationship expression: \vec{y}=α(W\vec{z}+\vec{b}), where \vec{x} is an input vector, \vec{y} is an output vector, \vec{b} is a bias vector, W is a weight matrix (also referred to as a coefficient), and α( ) is an activation function. At each layer, the output vector \vec{y} is obtained by performing such a simple operation on the input vector \vec{x}. Because there are many layers in the DNN, there are also many coefficients W and bias vectors \vec{b}. Definitions of these parameters in the DNN are as follows: The coefficient W is used as an example. It is assumed that in a DNN having three layers, a linear coefficient from the fourth neuron at the second layer to the second neuron at the third layer is defined as w. The superscript 3 represents a layer at which the coefficient W is located, and the subscript corresponds to an output third-layer index 2 and an input second-layer index 4. In conclusion, a coefficient from the k^{th} neuron at the (L−1)^{th} layer to the j^{th} neuron at the L^{th} layer is defined as

$${W}_{jk}^{L} .$$

It should be noted that there is no parameter W at the input layer. In the deep neural network, more hidden layers make the network more capable of describing a complex case in the real world.

Theoretically, a model with a larger quantity of parameters indicates higher complexity and a larger “capacity”, and indicates that the model can complete a more complex learning task. Training the deep neural network is a process of learning a weight matrix, and a final objective of the training is to obtain a weight matrix of all layers of the trained deep neural network (a weight matrix including vectors W at many layers).

### (3) Convolutional Neural Network

The convolutional neural network (CNN) is a deep neural network having a convolutional structure. The convolutional neural network includes a feature extractor including a convolutional layer and an optional sub sampling layer. The feature extractor may be considered as a filter. A convolution process may be considered as using a trainable filter to perform convolution on an input image or a convolutional feature plane (feature map). The convolutional layer is a neuron layer that is in the convolutional neural network and at which convolution processing is performed on an input signal. At the convolutional layer of the convolutional neural network, one neuron may be connected only to some adjacent-layer neurons. A convolutional layer usually includes a plurality of feature planes, and each feature plane may include some neurons arranged in a rectangular form. Neurons in a same feature plane share a weight. The shared weight herein is a convolution kernel. Weight sharing may be understood as that an image information extraction manner is irrelevant to a location. A principle implied herein is that statistical information of a part of an image is the same as that of another part. This means that image information learned in a part can also be used in another part. Therefore, image information obtained through same learning can be used for all locations in the image. At a same convolutional layer, a plurality of convolution kernels may be used to extract different image information. Usually, a larger quantity of convolution kernels indicates richer image information reflected by a convolution operation.

The convolution kernel may be initialized in a form of a random-size matrix. In a process of training the convolutional neural network, the convolution kernel may obtain an appropriate weight through learning. In addition, a direct benefit brought by weight sharing is that connections between layers of the convolutional neural network are reduced and an overfitting risk is lowered.

### (4) Recurrent Neural Network

A recurrent neural network (RNN) is used to process sequence data. In a conventional neural network model, from an input layer to a hidden layer and then to an output layer, the layers are fully connected, and nodes at each layer are not connected. Such a common neural network resolves many difficult problems, but is still incapable of resolving many other problems. For example, if a word in a sentence is to be predicted, a previous word usually needs to be used, because adjacent words in the sentence are not independent. A reason why the RNN is referred to as the recurrent neural network is that a current output of a sequence is also related to a previous output of the sequence. A specific representation form is that the network memorizes previous information and applies the previous information to calculation of the current output. To be specific, nodes at the hidden layer are connected, and an input of the hidden layer not only includes an output of the input layer, but also includes an output of the hidden layer at a previous moment. Theoretically, the RNN can process sequence data of any length. Training for the RNN is the same as training for a conventional CNN or DNN. An error back propagation algorithm is also used, but there is a difference: If the RNN is expanded, a parameter such as W of the RNN is shared. This is different from the conventional neural network described in the foregoing example. In addition, during use of a gradient descent algorithm, an output in each step depends not only on a network in the current step, but also on a network status in several previous steps. The learning algorithm is referred to as a back propagation through time (BPTT) algorithm.

Now that there is a convolutional neural network, why is the recurrent neural network required? A reason is simple. In the convolutional neural network, it is assumed that elements are independent of each other, and an input and an output are also independent, such as a cat and a dog. However, in the real world, many elements are interconnected. For example, stocks change with time. For another example, a person says: I like traveling, and my favorite place is Yunnan. I will go if there is a chance. If there is bank filling, people should know that “Yunnan” will be filled in the blank. A reason is that the people can deduce the answer based on content of the context. However, how can a machine do this? The RNN emerges. The RNN is intended to make the machine capable of memorizing like a human. Therefore, an output of the RNN needs to depend on current input information and historical memorized information.

### (5) Loss Function

In a process of training the deep neural network, because it is expected that an output of the deep neural network is as much as possible close to a predicted value that is actually expected, a predicted value of a current network and a target value that is actually expected may be compared, and then a weight vector of each layer of the neural network is updated based on a difference between the predicted value and the target value (certainly, there is usually an initialization process before the first update, to be specific, parameters are preconfigured for all layers of the deep neural network). For example, if the predicted value of the network is large, the weight vector is adjusted to decrease the predicted value, and adjustment is continuously performed until the deep neural network can predict the target value that is actually expected or a value that is very close to the target value that is actually expected. Therefore, “how to obtain, through comparison, a difference between a predicted value and a target value” needs to be predefined. This is the loss function or an objective function. The loss function and the objective function are important equations used to measure the difference between the predicted value and the target value. The loss function is used as an example. A higher output value (loss) of the loss function indicates a larger difference. Therefore, training of the deep neural network is a process of minimizing the loss as much as possible.

### (6) Transformer

A transformer is a deep learning architecture that relies on the parallel multi-head attention mechanism. The transformer includes two main components: an encoder and a decoder. The encoder may include encoding layers that sequentially process the input tokens, and similarly, the decoder may include decoding layers that iteratively process the encoder's output and the decoder's generated tokens. Each encoder layer is responsible for producing contextualized representations of the tokens. These representations capture information from other input tokens through the self-attention mechanism. In other words, each representation combines information from different input tokens to create a comprehensive understanding. On the other hand, each decoder layer contains two attention sublayers. The first sublayer, called cross-attention, incorporates the contextualized representations generated by the encoder. It enables the decoder to leverage the knowledge learned from the input tokens during the generation of output tokens. The second sublayer, known as self-attention, facilitates the integration of information among the input tokens within the decoder. This self-attention mechanism allows the decoder to consider the tokens that have already been generated, enabling it to automatically learn which tokens are important and need to be predicted accurately. In other words, through self-attention, the decoder can attend to and analyze the previously generated tokens during the sequence generation process, enhancing its understanding of context and making more precise predictions. To further enhance the processing of outputs, both the encoder and decoder layers include a feed-forward neural network. This network performs additional computations on the outputs. Additionally, residual connections and layer normalization steps are applied in both the encoder and decoder layers to improve the model's stability and performance. The transformer has found widespread applications in natural language processing (NLP) and computer vision tasks, including machine translation, text classification, image classification, speech recognition, and more.

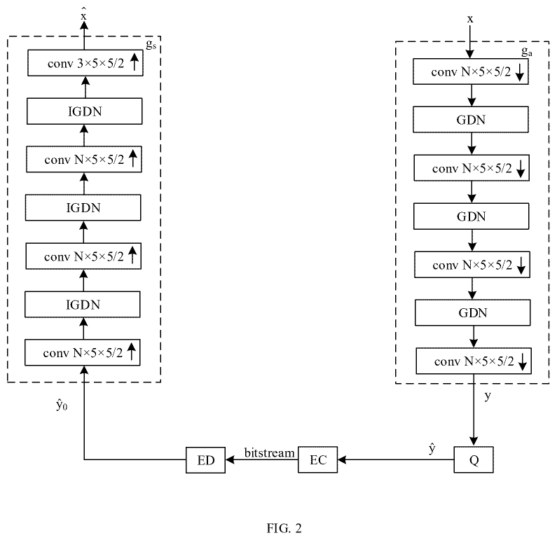

FIG. 2 illustrates a network architecture of a compression network. In FIG. 2, the following abbreviations and notations may be used.

gₐ may denote an analysis transform (e.g., an analysis transform operation) for transforming x into a latent representation y. gₛ may denote a synthesis transform (e.g., synthesis transform operation) for generating a reconstructed picture \hat{x}.

Rectangles marked with “conv” may denote convolutional layers. A convolutional layer may be represented by “the number of channels”×“kernel filter width”×“kernel filter height” and “down-scaling or up-scaling factor”. “↑” and “↓” respectively denote up-scaling and down-scaling through transposed convolutions.

An input picture input may be normalized to fit a scale between −1 and 1.

In a convolutional layer, “N” may indicate the number of feature map channels.

“GDN” may denote generalized divisive normalization (GDN). “IGDN” may denote inverse generalized divisive normalization (IGDN). “Q” may denote quantization e.g. uniform (rounding-off), or adaptive step size quantization. “EC” may denote an entropy-encoding process, “ED” may denote an entropy-decoding process.

Referring to FIG. 2, the analysis transform operation gₐ is used to transform an input picture x into a latent representation y. Next, y may be quantized into ŷ, and the entropy-encoding process may be performed to generate an encoded bitstream. The encoded bitstream may be decoded through the entropy-decoding process to obtain ŷ. The synthesis transform operation gₛ is performed on ŷ to generate a reconstructed picture.

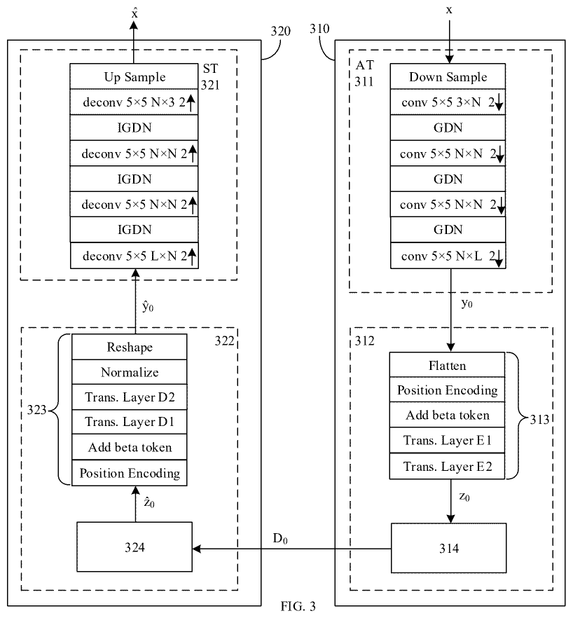

FIG. 3 illustrates a network architecture of a compression network in accordance with some embodiments of the present application. In FIG. 3, the following abbreviations and notations may be used.

“Down Sample” may denote a down-scaling process, and “Up Sample” may denote an up-scaling process.

Rectangles marked with “conv” may denote convolutional layers. A convolutional layer may be represented by “kernel filter height”×“kernel filter width”, “the number of input channels”×“the number of output channels” and “down-scaling or up-scaling factor”. “↑” and “↓” respectively denote up-scaling and down-scaling through transposed convolutions.

In block 311, “N” may indicate the number of input channels. “L” may indicate the number of output channels of the layer. In block 321, L may indicate the number of input channels, and N may indicate the number of output channels of the layer.

“GDN” may denote generalized divisive normalization (GDN). “IGDN” may denote inverse generalized divisive normalization (IGDN).

“Flatten” may denote a flatten process. The flatten process may be used to convert multidimensional data into one-dimensional format. For example, video frames or pictures are typically represented as two-dimensional arrays of pixel values. The flatten process may rearrange the pixel values into a single continuous line.

“Position Encoding” may denote a position encoding process that is used to encode spatial information or location within a video frame or a picture.

“Add beta token” may denote adding a weighted beta coefficient (controls the trade-off between rate and distortion) to the latent vector, in order to indicate how much information should be sent.

“Trans. Layer E1” may denote a Transformer encoder layer number 1, that relies on the parallel multi-head attention mechanism, which allows it to capture long-range dependencies.

“Trans. Layer E2” may denote a Transformer encoder layer number 2.

“Trans. Layer D1” may denote a Transformer decoder layer number 1.

“Trans. Layer D2” may denote a Transformer decoder layer number 2.

“Normalize” may denote a normalization layer, that calculates the mean and standard-deviation over the number of embedded dimensions and applies normalization to a given vector with learnable per-element affine parameters initialized to ones (for weights) and zeros (for biases).

“Reshape” may denote the procedure of reshaping latent vector in order to “anti-flatten” it—to get back two-dimensional arrays of pixel values instead of a single continuous line.

Referring to FIG. 3, the compression network includes two networks. A first network 310 is configured to derive an encoded bitstream according to an input image, and a second network 320 is configured to derive a reconstructed image corresponding to the encoded bitstream. Therefore, the first network 310 may be referred to as an encoding network, while the second network 320 may be referred to as a decoding network.

The encoding procedure performed by the first network may include two operations, where one of the two operations is an analysis transform operation 311, while the other operation may be referred to as a datastream deriving operation 312.

A neural network may be configured to implement the analysis transform operation 311. Referring to FIG. 3, the analysis transform operation 311 may include a convolutional layer and a nonlinear transformation unit. The nonlinear transformation unit is a network unit that contains nonlinear operations (such as ReLU, Sigmoid, Tanh, PWL, etc.). The overall computation of the nonlinear transformation unit does not conform to linear characteristics. The analysis transform operation 311 is configured to transform the input image from a signal space to a latent space. In other words, an output of the analysis transform operation is a latent representation of the input image.

The datastream deriving operation 312 may be configured to obtain the latent representation of the input image and derive a bitstream corresponding to the obtained latent representation. The datastream deriving operation 312 includes a bitstream deriving operation 314 and an encoding operation 313. The encoding operation 313 may be configured to obtain a feature tensor and relevant parameters from the latent representation of the input image. The bitstream deriving operation 314 is configured to derive a bitstream according to the feature tensor and the parameters obtained by the encoding operation 313.

The second network 320 may be configured to perform a decoding procedure, and the decoding procedure may include two operations, where one of the two operations is a synthesis transform operation 321, while the other operation may be referred to as a latent reconstructing operation 322. The latent reconstructing operation 322 may be configured to decode the encoded bitstream to obtain an output data in the latent space. The synthesis transform operation 321 is configured to transform the output data in the latent space to the reconstructed image in the signal space. A neural network may be configured to perform the synthesis transform operation 321.

The latent reconstructing operation 322 may include a decoding operation 323 and a tensor reconstructing operation 324. The tensor reconstructing operation 324 is configured to obtain a reconstructed feature tensor from the encoded stream, and the decoding operation 323 may be used to determine a reconstructed latent representation according to the reconstructed feature tensor. The reconstructed latent representation may be forwarded to the synthesis transform operation 321, and the synthesis transform operation 321 may determine a reconstructed image according to the reconstructed latent representation.

In general terms, the second network 320 may be regarded as an inverse operation of the first network 310. The latent reconstructing operation 322 may be regarded as an inverse operation of the datastream deriving operation 312, while the synthesis transform operation 321 may be regarded as an inverse operation of the analysis transform operation 311. Correspondingly, the decoding operation 323 may be regarded as an inverse operation of the encoding operation 313, and a tensor reconstructing operation 324 may be regarded as an inverse operation of the bitstream deriving operation 314.

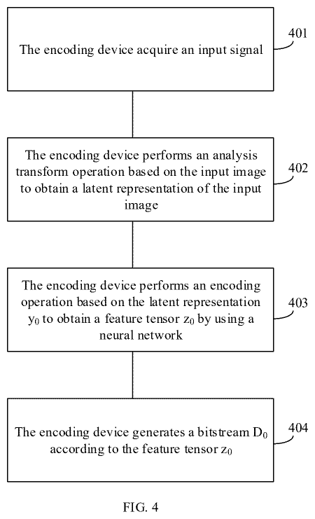

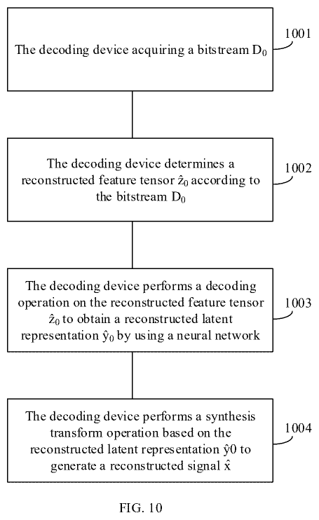

Details about the first network 310 may refer to FIG. 4, and details about the second network may refer to FIG. 10.

Although input data of the most embodiments of the present application is a video frame/picture/image, a type of the input data is not limited by the present application. The input data of the encoding device may be an image, a video, an audio, a 3D information, a text document, or the like.

The encoding operation 313 and the decoding operation 323 are based on transformer architecture. The encoding operation 313 and the decoding operation 323 may be implemented by other neural networks. For example, the encoding operation 313 and the decoding operation 323 may be based on a CNN, a RNN, and so forth.

FIG. 4 illustrates an encoding method according to some embodiments of the present application. For convenience, it is assumed that the operation illustrated in FIG. 4 is performed by an encoder or an encoding device. However, the operation illustrated in FIG. 4 may also be performed by a component of the encoder or the encoding device, such as a circuit in the encoder or the encoding device, or a chip or a system on chip (SoC) in the encoder/encoding device.

At operation 401, The encoding device acquire an input signal.

The input signal may be an image, a video frame, an audio or the like. For convenience, in the following embodiments, it is assumed that the input is an image. In other words, the input signal is an input image.

At operation 402, The encoding device performs an analysis transform operation based on the input image to obtain a latent representation of the input image. For convenience, letter “x” is used to symbolize the input image, and “y₀” is used to symbolize the latent representation of the input image. Therefore, the input image and the latent representation satisfies:

y₀=AT(x), (equation 1.1)

where AT ( ) represents the analysis transform operation.

At operation 403, The encoding device performs an encoding operation based on the latent representation y₀ to obtain a feature tensor z₀ by using a neural network.

The present application involves multiple neural networks. In order to distinguish these neural networks, the neural network that is used for performing the encoding operation may be referred to as an encoding neural network (ENC NN). As previously mentioned, the analysis transform operation may be performed by using a neural network, or another type of transforms like discrete cosine transform (DCT), wavelet, fast Fourier transform (FFT) etc. For convenience, the neural network which is used to perform the analysis transform operation may be referred to as an analysis transform neural network (AT NN).

At operation 404, The encoding device generates a bitstream D₀ according to the feature tensor z₀ by means of bitstream deriving operation 314.

In some embodiments, the encoding device may acquire an encoding information. Then the encoding device may generate the bitstream D₀ according to the encoding information and the feature tensor z₀. The size of the feature tensor z₀ is larger than a size of the bitstream D₀. In some embodiments, the encoding information may also be referred to as a decoding information obtained by training or other optimization process, and available for encoding and decoding device.

In some embodiments, the encoding information is singled with the bitstream D₀. In some embodiments, the encoding information may also be referred to as a decoding information.

In some embodiments, the encoding information is a length tensor N_{bits0}. In some embodiments, the length tensor N_{bits0} may be obtained according to the latent representation y₀ by using the ENC NN, more specifically as an output of encoding operation network 313.

In some embodiments, the encoding device may determine a mask tensor MSK₀ according to the length tensor N_{bits0} and an index tensor idx₀. Then, the encoding device determines the bitstream D₀ according to the mask tensor MSK₀ and the feature tensor z₀.

In some other embodiments, the encoding information (or the decoding information) may be fixed and obtained during a training process.

The mask tensor MSK₀ comprises X₁ first element(s) with a first value and X₂ second element(s) with a second value, X₁, a sum of X₁ and X₂ is the size of the feature tensor z₀, X₁ is a positive integer, X₂ is a positive integer. In other words, the number of the first element(s), the number of the second element(s), and the size of the feature tensor z₀ satisfy:

N_{size_z0}=Nₓ₁+Nₓ₂ (equation 1.2)

where N_{size_z0} is the size of the feature tensor z₀, Nₓ₁ is the number of the first element(s), and Nₓ₂ is the number of the second element(s).

For example, if the number of the first element(s) is 5 and the number of the second element(s) is 4, then the size of the feature tensor is 9.

In some embodiments, the first value may be 1, while the second value may be 0. In some other embodiments, the first value may be 0, while the second value may be 1. For convenience, in the following embodiments, it is assumed that the first value is 1, and the second value is 0.

The bitstream D₀ may include X₁ bit(s), and the feature tensor z₀ may include X₁ third element(s) and X₂ fourth element(s), where a location of each elements in the feature tensor z₀ is a same of a location of a corresponding element in the mask tensor MSK₀, a value of each of the X₁ third element(s) is the same as a value of a corresponding bit in the bitstream D₀.

In some embodiment, a binarization transform operation may be performed on the feature tensor z₀. An output of the binarization transform operation of the feature tensor z₀ may be referred to as a binary feature tensor \hat{z}₀. A function B(y) may be used to transform the feature tensor z₀ into the binary feature tensor z̅₀. The function B(y) may also be referred to as a binarization function. The binarization function B(y) may include the differentiable function. The feature tensor z₀ and the binary feature tensor z̅₀ may satisfy:

z̅₀=B(z₀), (equation 1.3).

In some embodiments, the binarization function B(y) may include a sigmoid function and a mathematical rounding function. The feature tensor z₀ is an input of the sigmoid function, an input of the mathematical rounding function is an output of the sigmoid function, and an output of the mathematical rounding function is the binary feature tensor z̅₀. The mathematical rounding function may be a round function, a ceil function, or a floor function. For example, when the mathematical rounding function is the round function, the binary feature tensor z̅₀ and the feature tensor z₀ may satisfy:

z̅₀=round(sigmoid(z₀)), (equation 1.4)

where round ( ) denotes the round function, and sigmoid ( ) denotes the sigmoid function.

When the binarization transform operation is performed, the bitstream D₀ may be determined according to the binary feature tensor z̅₀. The binary feature tensor z̅₀ may also include X₁ third element(s) and X₂ fourth element(s), where a value of the third element may be the same as the value of the first element, and a value of the fourth element may be the same as the value of the second element.

For example, the feature tensor z₀ may be:

$${z}_{0} = ( \begin{matrix}- 0.1 & 1.2 & 2.8 \\ 0.9 & - 1.4 & - 0.7 \\ 1.3 & - 2.3 & - 0.9\end{matrix} ) ,$$

and each row of the feature tensor z₀ is a feature of the input image. The binary feature tensor z̅₀ determined according to the above-mentioned equation (1.4) is

$${\overline{z}}_{0} = ( \begin{matrix}0 & 1 & 1 \\ 1 & 0 & 0 \\ 1 & 0 & 0\end{matrix} ) .$$

In this example, the third elements of the binary feature tensor z̅₀ include the elements with a value of 1, and the fourth elements include the element with a value of 0.

The binarization function B(y) may make all output values set to 0 or 1 preserving gradients of the feature tensor z₀. The sigmoid function is an example function which is used to convert the fundamental feature tensor z₀ into the fundamental binary feature tensor z̅₀, and the sigmoid function in the above-mentioned equations may be replaced by any other differentiable function f(z₀) with values range between 0 and 1. For example, f(z₀)=(tan h(z₀)+1)/2, f(z₀)=(softsign(z₀)+1)/2, where tanh( ) denotes a hyperbolic tangent function, and softsing ( ) denotes a softsign function.

The index tenor idx₀ is a tensor of the same shape as the binary feature tensor z̅₀. For example, if binary feature tensor

$${\overline{z}}_{0} = ( \begin{matrix}0 & 1 & 1 \\ 1 & 0 & 0 \\ 1 & 0 & 0\end{matrix} ) ,$$

the index tensor idx₀ is a 3×3 matrix. Values of the index tenor idx₀ is determined according to a dimensional parameter N_{max_0}. For example, the index tensor idx₀ may be filled continuously with values from 0 to N_{max_0}, where N_{max_0} is dimension along which number of bits should be cut. A relationship between the index tenor idx₀ and the dimensional parameter N_{max_0} may be:

idx₀=tensor([0, 1, 2, 3, . . . , N_{max_0}]), (equation 1.5)

where tensor ( ) denotes a tensor of the same shape as the binary feature tensor z̅₀. If the binary feature tensor

$${\overline{z}}_{0} = ( \begin{matrix}0 & 1 & 1 \\ 1 & 0 & 0 \\ 1 & 0 & 0\end{matrix} ) ,$$

the dimensional parameter N_{max_0} may be 2, and the index tensor idx₀ may be

$${idx}_{0} = ( \begin{matrix}0 & 1 & 2 \\ 0 & 1 & 2 \\ 0 & 1 & 2\end{matrix} ) .$$

As previously mentioned, the encoding device may determine the mask tensor MSK₀ according to the length tensor N_{bits0} and an index tensor idx₀. The mask tensor MSK₀ is a tensor of the same shape as the index tensor idx₀, and values of the tensor (that is, MSK₀) may be determined according to the length tensor N_{bits0} and the index tensor idx₀. When the size of the input image is W×H, the size of the feature tensor (or the binary feature tensor) may be w×h×c, where W and w are the number of columns, H and h are the number of rows, and c is the number of channels or features for each latent space, w is smaller than W, h is smaller than H, and all of these elements (that is, W, H, w, h, and c) are positive integer. In addition, the size of the length tensor N_{bits0} may be l×h×c. The length tensor N_{bits0} specifies how may features of the binary feature tensor \hat{z}₀ need to be transferred from every latent space position of the binary feature tensor z̅₀. In other words, the length tensor N_{bits0} shows how much values (features of the latent space) will be taken in each rows of the binary feature tensor z̅₀, and the remaining values are discarded, and therefore the binary feature tensor z̅₀ is compressed. In addition, the index tensor idx₀ and the mask tensor MSK₀ may be the same size as the binary feature tensor z̅₀. Each element of a x^{th} row in the h rows of the index tensor idx₀ may be compared with an element of a x^{th} row in the h rows of the length tensor N_{bits0}. For convenience, V_{idx0_x_y} may be referred to as a value of a y^{th} element in the x^{th} row of the index tensor idx₀, V_{bits0_x} may be referred to as a value of the element in the x^{th} row of the length tensor N_{bits_0}, and V_{msk0_x_y} may be referred to as a value of y^{th} element in the x^{th} row of the mask tensor MSK₀. When V_{idx0_x_y} is larger than or equal to V_{bits0_x}, V_{msk0_x_y} is set to 0; V_{idx0_x_y} is less than V_{bits_0_x}, V_{msk0_x_y} is set to 1.

For example, if

$${idx}_{0} = ( \begin{matrix}0 & 1 & 2 \\ 0 & 1 & 2 \\ 0 & 1 & 2\end{matrix} ) and {N}_{bits 0} = ( \begin{matrix}2 \\ 0 \\ 3\end{matrix} ) ,$$

then

$${MSK}_{0} = ( \begin{matrix}1 & 1 & 0 \\ 0 & 0 & 0 \\ 1 & 1 & 1\end{matrix} ) .$$

The mask tensor MSK₀ may be configured to extract bit(s) from the binary feature tensor z̅₀ to construct the encoded bitstream D₀. As previous mentioned, the size of the mask tensor MSK₀ may be the same as the size of the binary feature tensor z̅₀. Elements of the mask tensor MSK₀ may be in one-to-one correspondence with elements of the binary feature tensor z̅₀. When a value of an element of the mask tensor MSK₀ corresponding to an element of the binary feature tensor z̅₀ is equal to 1, the element of the binary feature tensor z̅₀ may be extracted as a bit in the encoded bitstream, otherwise the element may be ignored. In other words, the size of the encoded bitstream Do may be equal to the number of elements in MSK₀ that have a value of 1.

For example, if

$${\overline{z}}_{0} = ( \begin{matrix}0 & 1 & 1 \\ 1 & 0 & 0 \\ 1 & 0 & 0\end{matrix} )$$

and

$${MSK}_{0} = ( \begin{matrix}1 & 1 & 0 \\ 0 & 0 & 0 \\ 1 & 1 & 1\end{matrix} ) ,$$

an element in the first row and first column of z̅₀ corresponds to an element in the first row and first column of MSK₀. Since the value of the element in the first row and first column MAK₀ is 1, the element in the first row and first column of z̅₀ may be reserved as a bit in the encoded bitstream D₀. Similarly, since a value of an element in a first row and second column of MSK₀ is 1, an element in the first row and second column of z̅₀ may be reserved as a bit in the encoded bitstream D₀. However, a value of an element in the first row and third column of MSK₀ is 0, then an element in the first row and third column of z̅₀ may be ignored. Based on the same principle, the fundamental encoded bitstream D₀ may be obtained, and D₀=01100.

In some other embodiments, the binarization transform operation may be performed after the element extraction procedure mentioned in the previous paragraph. Similarly, when a value of an element of the mask tensor MSK0 corresponding to an element of the feature tensor z₀ is equal to 1, the element of the feature tensor z₀ may be extracted as a bit in the encoded bitstream, otherwise the element may be ignored. For example,

$${MSK}_{0} = ( \begin{matrix}1 & 1 & 0 \\ 0 & 0 & 0 \\ 1 & 1 & 1\end{matrix} )$$

may be used to extract elements from the feature tensor

$${z}_{0} = ( \begin{matrix}- 0.1 & 1.2 & 2.8 \\ 0.9 & - 1.4 & - 0.7 \\ 1.3 & - 2.3 & - 0.9\end{matrix} ) .$$

Elements extracted from z₀ may be (−0.1, 1.2, 1.3, −2.3, −0.9). The binarization transform operation may be performed on the extracted elements to obtain then encoded bitstream D₀.

In some embodiments, the encoding device may transmit the encoded bitstream D₀ to a decoding device. Correspondingly, the decoding device may receive the encoded bitstream D₀ from the encoding device and decode the bitstream D₀ to obtain the reconstructed image. The decoding device may determine a reconstructed feature tensor \hat{z}₀ and perform a decoding operation on the reconstructed feature tensor \hat{z}₀ to obtain a reconstructed latent representation ŷ₀ by using a neural network. For convenience, the neural network that is used to obtain the reconstructed latent representation ŷ₀ may be referred to as a DEC NN. After obtaining the reconstructed latent representation ŷ₀, the decoding device may perform a synthesis transform operation based on the reconstructed latent representation ŷ₀ to generate a reconstructed signal \hat{x}.

In some embodiments, in addition to the encoded bitstream D₀, the decoding device need additional information to decode the encoded bitstream D₀. For convenience, the additional information that is sued to decode the encoded bitstream D₀ may be referred to as a decoding information. Correspondingly, the decoding information can be known on decoding device in advance, or, alternatively, the encoding device may transmit the decoding information to the decoding device.

In some embodiments, the decoding information may include the length tensor N_{bits0}. The decoding device may determine the mask tensor MSK₀ according to the index tensor idx₀ and the length tensor N_{bits0} and determine the reconstructed feature tensor \hat{z}₀ according to the encoded bitstream D₀ and the mask tensor MSK₀. In some other embodiments, the decoding information may further include the index tensor idx₀. In some other embodiments, the decoding device may determine the index tensor idx₀ according to the dimensional parameter N_{max_0}. Details about how to determine the index tensor according to the dimensional parameter may refer to the above-mentioned embodiments and will not be described here.

In some other embodiments, the decoding information may include the mask tensor MSK₀. The decoding device may determine the reconstructed feature tensor \hat{z}₀ according to the encoded bitstream D₀ and the mask tensor MSK₀.

As previously described, in some embodiments, the decoding information may include the mask tensor MSK₀. In some other embodiments, the decoding information may include the length tensor N_{bits0}. In some embodiments, the decoding information including the mask tensor MSK₀, or, the length tensor N_{bits_0} may be referred to as a fundamental decoding information. Further, for convenience, the term “datastream information” is used to refer to the information that is sent from the encoding device to the decoding device. As discussed previously, in some embodiments, the datastream information may include the encoded bitstream and the mask tensor MSK₀. In some other embodiments, the datastream information may include the encoded bitstream and the length tensor N_{bits_0}. In other words, the datastream information may include the encoded bitstream and the decoding information. In some embodiments, a datastream information including the encoded bitstream D₀ and the fundamental decoding information may be referred to as a fundamental datastream information.

In some embodiments, the encoding device may determine at least one additional encoded bitstream and transmit the at least one additional encoded bitstreams to the decoding device. The decoding device may determine the reconstructed image according to the encoded bitstream D₀ and the at least one additional encoded bitstream. Correspondingly, decoding information corresponding to the at least one additional encoded bitstream may also be transmitted to the decoding device. For convenience, it is assumed that, in addition to the fundamental datastream information, the encoding device may transmit M piece(s) of datastream information to the decoding device. Corresponding, the decoding device may receive the M piece(s) of datastream information. M is a positive integer. Each of the M piece(s) of datastream information includes an encoded bitstream and a decoding information corresponding to the encoded bitstream. The M piece(s) of datastream information may be obtained through M encoding operation(s) and M decoding operation(s). For convenience, an encoding operation which is used for obtaining the fundamental datastream information may be referred to as a fundamental encoding operation, while, unless otherwise indicated, the term “encoding operation” in the following is referred to as the encoding operation for obtaining one of the M piece(s) of datastream information. In other words, unless otherwise indicated, the term “encoding operation” is one of the M encoding operation(s) mentioned in the following context. Similarly, the term “datastream information” is referred to as one of the M piece(s) of datastream information unless otherwise indicated.

In some embodiments, M may be equal to one. In this case, the encoding device may perform one decoding operation on the fundamental datastream information to obtain a reconstructed image and one encoding operation based on the reconstructed image. For convenience, the image that is used to determine the fundamental encoding information may be referred to as a pre-coding data. The decoding operation which is performed on the fundamental datastream information to obtain a reconstructed image may be referred to as a decoding operation #1. The encoding operation for obtaining the fundamental datastream information may be referred to as an encoding operation #0. The encoding operation based on the reconstructed image may be referred to as an encoding operation #1. In conclusion, the encoding device may obtain the pre-coding data (hereinafter, referred to as “x”) and perform the encoding operation #0 on the pre-coding data to obtain the fundamental datastream information (hereinafter, referred to as “bits₀”) including the encoded bitstream D₀ and the fundamental decoding information. Then, the encoding device may perform the decoding operation #1 according to bits0 to obtain a reconstructed data (hereinafter, referred to as “rec₁”). In addition, the encoding device may perform the encoding operation #1 on [x-rec₁] to obtain a datastream information (hereinafter, referred to as “bits₁”) including an encoded bitstream and a decoding information corresponding to the encoded bitstream. Details of the encoding operation #1 may be the same as that of the encoding operation #0. For example, the encoding operation #1 may include an encoding operation #1 performed on [x-rec1] by using the ENC NN. Details of the encoding operation #1 may refer to FIG. 3 and FIG. 4 and will not be described here.

The encoding device may transmit the fundamental datastream information bits₀ and the datastream information bits₁ to the decoding device. Corresponding, the decoding device may receive the fundamental datastream information bits₀ and the datastream information bits₁ from the encoding device and decode the fundamental datastream information bits₀ and the datastream information bits₁ to obtain the reconstructed image.

In some embodiments, M may be greater than one. In this case, the encoding device may perform the decoding operation M times and perform the encoding operation M times, and M encoding operations do not include the fundamental encoding operation for obtaining the fundamental datastream information. For convenience, a m^{th} decoding operation among the M decoding operations may be referred to a decoding operation #m, and m=1, . . . , M. A m^{th} encoding operation among the M encoding operation may be referred to an encoding operation #m. The fundamental encoding operation for obtaining the fundamental datastream information may be referred to as an encoding operation #0.

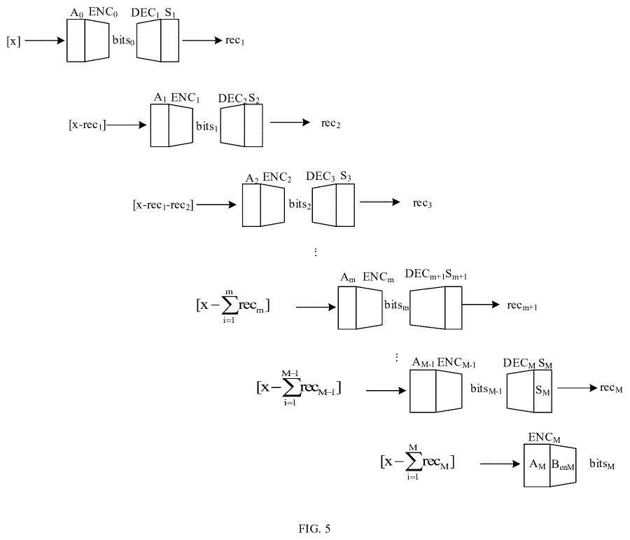

FIG. 5 illustrates an encoding method according to some embodiments of the present application. Referring to FIG. 5, the encoding method performed by an encoding device includes the fundamental encoding procedure, the M decoding procedures and the M encoding procedures. For convenience, for the encoding procedure illustrated in FIG. 5, it is assumed that M is a positive integer greater than 4.

As previously mentioned, after performing the encoding operation, the encoding device may perform the bitstream deriving operation to obtain the encoded bitstream. Meanwhile, before performing the decoding operation, the encoding device may perform the tensor reconstructing operation, and the decoding operation is performed on the result of the tensor reconstructing operation. In other words, the encoding operation has a corresponding bitstream deriving operation, and the decoding operation has a corresponding tensor reconstructing operation. For convenience, “ENCⱼ” illustrated in FIG. 5 refer to the encoding operation and the bitstream deriving operation corresponding to the encoding operation, and “DECⱼ” illustrated in FIG. 5 refers to the decoding operation and the tensor reconstructing operation corresponding to the decoding operation, where j=1, . . . , M. In other words, ENCⱼ illustrated in FIG. 5 corresponds to the block 312 illustrated in FIG. 3, and ENCⱼ includes the encoding operation #j and the bitstream deriving operation corresponding to the encoding operation #j (hereinafter referred to as “bitstream deriving operation #j”). Similarly, DECⱼ illustrated in FIG. 5 illustrated the block 322 illustrated in FIG. 3, and DECⱼ includes the decoding operation #j and the tensor reconstructing operation corresponding to the decoding operation #j (hereinafter referred to as “tensor reconstructing operation #j”).

Referring to FIG. 5, bits₀ is obtained by ENC₁, bits₁ is the datastream information obtained by ENC₂, bits₂ is the datastream information obtained by ENC₃, and so forth; rec₁ is a decoding result obtained by DEC₁ and a synthesis transform corresponding to DEC₁ (that is S₁), rec₂ is a decoding result obtained by DEC₂ and a synthesis transform corresponding to DEC₂ (that is S₂), and so forth. A₀ refers to the analysis transform operation corresponding to ENC₀. In other words, ENC₀ (that is, the encoding operation #0 and the bitstream deriving operation #0) is performed on a result of A₀. Similarly, A₁ refers to the analysis transform operation corresponding to ENC₁, A₂ refers to the analysis transform operation corresponding to ENC₂, and so forth. S₁ refers to the synthesis transform operation corresponding to DEC₁. In other words, S₁ is performed on a result of the decoding operation #1, and the transformed result of S₁ is rec₁. Similarly, S₂ refers to the synthesis transform operation corresponding to DEC2, S₃ refers to the synthesis transform operation corresponding to DEC₃, and so forth. For convenience, the ENC₀ and its corresponding analysis transform operation (that is, A₀) may be referred to as an encoding procedure #0, ENC₁ and its corresponding analysis transform operation (that is, A₁) may be referred to as an encoding procedure #1, ENC₂ and its corresponding analysis transform operation (that is, A₂) may be referred to as an encoding procedure #2, and so on. Similarly, DEC₁ and its corresponding synthesis transform operation (that is, S₁) may be referred to as a decoding procedure #1, DEC₂ and its corresponding synthesis transform operation (that is, S₂) may be referred to as a decoding procedure #2, and so on.

Referring to FIG. 5, the encoding device performs the encoding procedure #1 on [x-rec₁]. In other words, the encoding procedure #1 is performed based on the pre-coding data (that is “x” in FIG. 5) and rec₁. Since the encoding procedure #1 is performed based on the decoding result obtained by the decoding procedure #1, the decoding procedure #1 may be referred to as a decoding procedure corresponding to the encoding procedure #1. The encoding device performs the encoding procedure #2 on [x-rec₁-rec₂]. In other words, the encoding procedure #2 is performed based on the pre-coding data, rec₁, and rec₂. Similarly, the decoding procedure #2 is a decoding procedure corresponding to the encoding procedure #2. As the encoding procedure #1 includes the encoding operation #1 and the decoding procedure #1 includes the decoding operation #1, the decoding operation #1 may be referred to as a decoding operation corresponding to the encoding operation #1. Similarly, the decoding operation #2 may be referred to as a decoding operation corresponding to the encoding operation #2, and so on. Therefore, for the m^{th} encoding operation, the encoding device performs the encoding operation #m based on

$$[ x - {\sum }_{i = 1}^{m} {rec}_{i} ] ,$$

and the decoding operation #m is a decoding operation corresponding to the encoding operation #m. More specifically, the encoding device performs the encoding operation #m on

$$AT ( [ x - {\sum }_{i = 1}^{m} {rec}_{i} ] ) ,$$

where AT ( ) denotes the analysis transform operation. If ŷ is the reconstructed latent representation obtained by decoding operation, then rec=ST(ŷ). Therefore, the input of the encoding operation #m may also be expressed as

$$AT ( [ x - {\sum }_{i = 1}^{m} ST ( {\hat{y}}_{i} ) ] ) ,$$

where AT( ) denotes the analysis transform operation, ST ( ) denotes the synthesis transform operation, x is the input signal, and ŷᵢ is an i^{th} reconstructed latent representation among the m reconstructed latent representation(s). Details of the encoding operation #m may be the same as that of the encoding operation #0. For example, the encoding operation #m may be performed by using the ENC NN. Details of the encoding operation #1 may refer to FIG. 3 and FIG. 4 and will not be described here.

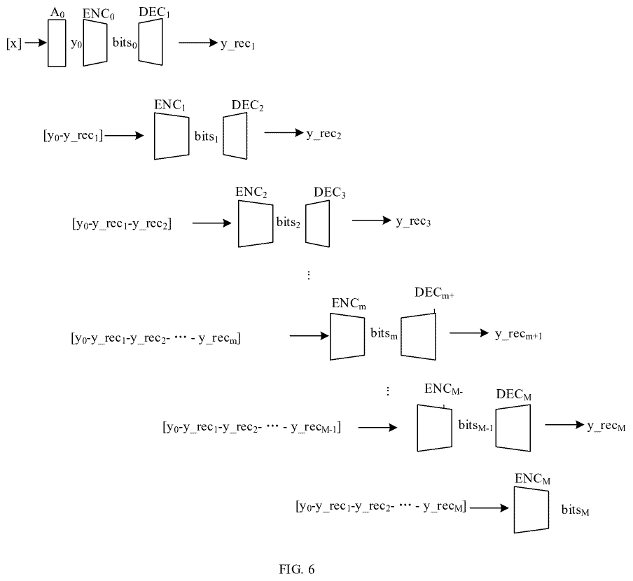

FIG. 6 illustrates another encoding method according to some embodiments of the present application. Referring to FIG. 6, the encoding method performed by an encoding device includes a fundamental encoding operation, M decoding operations and M encoding operations. Similar to FIG. 5, “ENCⱼ” illustrated in FIG. 6 refer to the encoding operation and the bitstream deriving operation corresponding to the encoding operation, and “DECⱼ” illustrated in FIG. 6 refers to the decoding operation and the tensor reconstructing operation corresponding to the decoding operation, where j=1, . . . , M.

Similar to FIG. 5, bits₀ is obtained by ENC₁, bits₁ is the datastream information obtained by ENC₂, bits₂ is the datastream information obtained by ENC₃, and so forth; rec₁ is the decoding result obtained by DEC₁, rec₂ is the decoding result obtained by DEC₂, and so forth. A₀ refers to the analysis transform operation corresponding to the fundamental encoding operation (that is, the encoding operation #0 included in ENC₀).

Referring to FIG. 6 only ENC₀ has a corresponding analysis transform operation (that is, A₀) and other ENCs does not have the corresponding analysis transform operation. Referring to FIG. 6, each of the M ENCs corresponds to a DEC. When the ENC does not have the analysis transform operation, the corresponding DEC does not have a corresponding synthesis transform operation.

For example, ENC₁ corresponds to DEC₁, ENC₂ corresponds to DEC₂.

Referring to FIG. 5 and FIG. 6, each of the DECs has a corresponding ENC. Since each of the DECs includes a decoding operation and each of the ENCs includes an encoding operation, it may be asserted that each of the decoding operations included in the DECs has a corresponding encoding operation, and the decoding operation may be performed on an input data determined according to the bitstream generated by the corresponding encoding operation. For example, in FIG. 6, DEC₁ decodes the bitstream generated by ENC₀, DEC₂ #2 decodes the bitstream generated by ENC₁. y_rec₁ is an output of DEC₁, and y_rec₁ may be a reconstructed latent representation corresponding to the encoded bitstream carried by bits₀. In some embodiments, the reconstructed latent representation corresponding to the encoded bitstream carried by bits₀ may also be referred to as a reconstructed latent representation ŷ₀. Similarly, y_rec₂ is an output of DEC₂, and y_rec₂ may also be referred to as a reconstructed latent representation ŷ₁, and so on. As illustrated in FIG. 6, input of ENCₘ is [y₀-y_rec₁-y_rec₂- . . . - y_recₘ]. If y_recⱼ is replaced by ŷⱼ₋₁, the input of ENCₘ may be

$${y}_{0} - {\sum }_{i = 1}^{m} {\hat{y}}_{i} .$$

As previously mentioned, ENCₘ includes the encoding operation #m and the bitstream deriving operation #m, and the bitstream deriving operation #m is performed according to the output of the encoding operation #m. Therefore, it ma be asserted that the encoding device performs the encoding operation #m based on

$${y}_{0} - {\sum }_{i = 1}^{m} {\hat{y}}_{i} .$$

For convenience, the term “CODEC” may be referred to a DEC and an ENC corresponding to the DEC. For example, CODEC₀ may include the ENC₀ and the DEC₁, CODEC₁ may include the ENC₁ and the DEC₂, CODEC₂ may include the ENC₂ and the DEC₃, and so on. When the encoding procedure includes M decoding operations and M encoding operations, there are M CODECs, that is the CODEC₀ to CODEC_{M-1}, and CODECⱼ includes the ENCⱼ and the DECⱼ₊₁, where j=1, . . . , M−1. For the embodiments illustrated in FIG. 5 and FIG. 6, except for the CODEC₀, input data of each of the CODEC₁ to the CODEC_{M-1} is derived according to the decoded information of the previous CODEC(s) and the pre-coding data (that is “x”).

In some embodiments, the encoding device may perform one or more the analysis transform operations. When the encoding device performs a plurality of the analysis transform operations, input data of the first analysis transform operation of the plurality of the analysis transform operations is the pre-coding data (that is the input image), and input data of the second analysis transform operation to the last analysis transform operation is output data of the previous analysis transformation. For example, it is assumed that the encoding device may perform the analysis transform operation K time(s). When K is equal to one (in other words, the encoding device only performs the analysis transform operation once), the input data of the analysis transformation is the pre-coding data. When K is a positive integer larger than 1, the input data of the first analysis transform operation is the pre-coding data, and the input data of the second analysis transform operation is the output data of the first analysist transform operation, and so on.

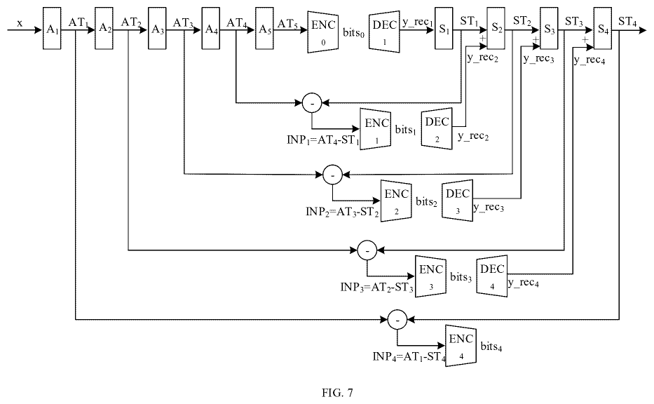

FIG. 7 illustrates an encoding method according some embodiments of the present application. Referring to FIG. 7, the encoding device performs 5 analysis transform operations, and the 5 analysis transform operations may be referred to as the analysis transform operation #1 to #5 respectively, where A₁ in FIG. 7 denotes the analysis transform operation #1, A₂ denotes the analysis transform operation #2, and so on. “x” in FIG. 7 is the pre-coding data, AT₁ is the output data of the analysis transform operation #1, AT₂ is the output data of the analysis transform operation #2, and so on. As illustrated in FIG. 7, the input data of the analysis transform operation #1 (that is, A₁) is the pre-coding data (that is, x), the input data of the analysis transform operation #2 (that is, A₂) is AT₁ (that is, the output data of the analysis transform operation #1), the input data of the analysis transform operation #3 (that is, A₃) is A₂ (that is, the output data of the analysis transform operation #2), and so forth.

The encoding device may perform an encoding operation on the output data of the last of the K analysis transform operation (in other words, the K^{th} analysis transform operation, or, the analysis transform operation #K) to generate the fundamental datastream information. For convenience, the encoding operation for generating the fundament datastream information may be referred to as a fundamental encoding operation. In addition to the fundamental encoding operation, the encoding device may perform M encoding operation(s) and M decoding operation(s) to generate M datastream information, where M is a positive integer. For convenience, unless otherwise indicated, the term “encoding operation” in the following is referred to as one of the M encoding operation(s). Similarly, the term “datastream information” is referred to as one of the M datastream information unless otherwise indicated. As previously mentioned, each encoding operation has a corresponding bitstream deriving operation that is used to generate the encoded bitstream, and each decoding operation has a corresponding tensor reconstructing operation that is used to generate the reconstructed tensor feature according to the encoded bitstream. Therefore, similar to FIG. 5, “ENCⱼ” illustrated in FIG. 7 refer to the encoding operation and the bitstream deriving operation corresponding to the encoding operation, and “DECⱼ” illustrated in FIG. 7 refers to the decoding operation and the tensor reconstructing operation corresponding to the decoding operation, where j=1, . . . , M.

Referring to FIG. 7, the encoding device may perform ENC₀ on AT₅ (that is, the output data of the analysis transform operation #5) to generates the fundament datastream information (that is, bits₀). Further, the encoding device performs 4 decoding operations and 4 encoding operations to generates 4 datastream information (that is, bits₁ to bits₄). In order to generate the 4 datastream information, the encoding device further performs 4 synthesis transform operations. For convenience, the 4 decoding operations may be referred to as the decoding operation #1 to #4 respectively, the 4 encoding operations may be referred to as the encoding operation #1 to #4 respectively, and the 4 synthesis transform operations may be referred to as the synthesis transform operation #1 to #4. The encoding device performs the decoding operation #1 based on bits₀ to obtain a reconstructed latent representation #1 (that is, y_rec₁) and performs the synthesis transform operation #1 on the reconstructed latent representation #1. The output data of the synthesis transform operation #1 may be referred to as ST₁. Similarly, the output data of the synthesis transform operation #2 to #4 may be referred to as ST₂ to ST₄ respectively.

After obtaining ST₁, the encoding device may determine that the input data of ENC₁ is determined according to AT₄ and ST₁. INP₁ denotes the input data of the encoding operation #1. As illustrated in FIG. 7, INP₁, ST₁ and AT₄ satisfy: INP₁=AT₄−ST₁. After determining INP₁, the encoding device may perform ENC₁ on INP₁ to obtain a datastream information #1 (that is, bits₁). In addition, the encoding device may perform DEC₂ on bits₁ to obtain a reconstructed latent representation #2 (that is, y_rec₂). According to y_rec₂ and ST₁, the encoding device performs the synthesis transform operation #2 (that is, S₂). Input data of the synthesis transform operation #2 is the sum of y_rec₂ and ST₁. Then, the encoding device may determine the input data of ENC₂ based on the output of the synthesis transformation #2 (that is, ST₂) and the output of the analysis transform operation #3 (that is, AT₃) and perform ENC₂ on the determined input data. As previously mentioned, ENC includes the encoding operation and the bitstream deriving operation, and the bitstream deriving operation #m is performed according to the output of the encoding operation. Therefore, the input data of the ENC may be regarded as the input data of the encoding operation included in the ENC. For example, the input data of the ENCₘ may be regarded as the input data of the encoding operation #m.

In summary, input data of the m^{th} encoding operation (in other words, input data of the encoding operation #m) satisfy:

INPₘ=AT_{K-m}−STₘ, (2.1)

where INPₘ is the input data of the m^{th} encoding operation, AT_{K-m} is a result of a (K−m)^{th} analysis transform operation among the K analysis transform operations; STₘ is a result of a m^{th} synthesis transform operation among K synthesis transform operations, and the m^{th} synthesis transform operation is performed on a target data determined according to the m decoded bitstream(s). m is a positive integer and less than or equal to M. M is equal to K−1.

A target data of a synthesis transform operation may also be referred to as an input data of the synthesis transform operation. For example, referring to FIG. 7, the synthesis transform operation #1 is performed on the reconstructed latent representation #1 (that is, y_rec₁). So, the reconstructed latent representation #1 is the target data (or the input data) of the synthesis transform operation #1, and the reconstructed latent representation #1 is determined according to the first decoding operation (that is, the decoding operation included in DEC₁). For the target data of the synthesis transform operation #2 (that is, S₂), ST₁ and y_rec₂, y_rec₂ is determined according to the second decoding operation (that is, the decoding operation included in DEC₂), ST₁ is determined according to the reconstructed latent representation #1 determined according to the first decoding operation (that is, the decoding operation included in DEC₁). Therefore, the target data of the synthesis transform operation #2 is determined according to the first two decoding operations (that is, the decoding operations included in DEC₁ and DEC₂). For the target data of the synthesis transform operation #3 (that is, S₃), ST₂ and y_rec₃, y_rec₃ is determined according to the third decoding operation (that is, the decoding operation included in DEC₃), ST₂ is determined according ST₁ and y_rec₂, where y_rec₂ is determined according to the second decoding operation (that is, the decoding operation included in DEC₂), ST₁ is determined according to the reconstructed latent representation #1 determined according to the first decoding operation (that is, the decoding operation included in DEC₁). Therefore, the target data of the synthesis transform operation #3 is determined according to the first three decoding operations (that is, the decoding operations included in DEC₁, DEC₂, and DEC₃). Therefore, the m^{th} synthesis transform operation is performed on a target data determined according to the m reconstructed latent representation(s).

In some embodiments, the encoding device may perform a first variation operation on the input data of at least one of the fundamental encoding operation and the M encoding operation(s). The first variation operation may include at least one of a sampling variation operation, a linear transformation, or an analysis transformation, and the sampling variation operation may be an up-sampling operation or a down-sampling operation.

Depending on whether the variation operation is performed, the M+1 encoding operation (that is, the fundamental encoding operation and the M encoding operation) may be referred to as the first encoding operation and the second encoding operation, where the first encoding operation is the encoding operation (or the fundamental encoding operation) on which the variation operation is performed, and the second encoding operation is the encoding operation (or the fundamental encoding operation) on which the variation operation is not performed. Further, an input data of the first encoding operation may be referred to as the first input data, while an input data of the second encoding operation may be referred to as a second input data. Therefore, the encoding device may perform the variation operation on the first input data, then the encoding device may perform the rest process of the encoding operation based on the varied first input data.

As previously mentioned, each decoding operation has a corresponding encoding operation, and the decoding operation determines a reconstructed latent representation according to the bitstream determined according to the corresponding encoding operation. When the encoding operation of the corresponding encoding operation is the first encoding operation, a variation operation corresponding to the first variation operation may be performed on a result of the decoding operation in the decoding operation. For convenience, the variation operation corresponding to the first variation operation may be referred to as a second variation operation. Similarly, depending on whether the second variation operation is performed, the M decoding operation may be referred to as the first decoding operation and the second decoding operation, where the first decoding operation is the decoding operation on which the second variation operation is performed, and the second decoding operation is the decoding operation on which the second variation operation is not performed. When the encoding operation of a CODEC is the first encoding operation, the decoding operation of the CODEC is the first decoding operation; when the encoding operation of a CODEC is the second encoding operation, the decoding operation of the CODEC is the second decoding operation.

Thank a down-sampling operation and an up-sampling operation as an example, the down-sampling operation and the up-sampling operation may be performed with one or more layers of the neural network for performing the decoding/encoding operation (that is, the ENC NN or the DEC NN). When the Enc/DEC NN comprises one or more layers which perform the down-sampling operation or the up-sampling operation, then it may be regarded that a variation operation is performed on the encoding/decoding operation performed by using the Enc/DEC NN. When the first variation operation is a down-sampling operation, the second variation operation comprises an up-sampling operation; when the first variation operation is the up-sampling operation, the second variation operation is the down-sampling operation. For example, referring to FIG. 5, when a down-sampling operation (e.g., downscaling 8 times) is performed on the input data of the encoding operation belonging to ENC₀, an up-sampling operation (e.g., upscaling 8 times) is performed on the output data of the decoding operation belonging to DEC₁.

When the first variation operation is a linear transform operation, the second variation operation is a linear transform operation. Referring to FIG. 6, when a linear transform operation is performed on the input data of the encoding operation belonging to ENC₁, another linear transform operation may be performed on the output data of the decoding operation belonging to DEC₂. The linear transform operation performed on the encoding side may allow to not only transform input tensor from one dimension to another if necessary, but also reorder input channel by their importance, which becomes very useful when finetuning model with preloaded analysis and synthesis transform operations checkpoints is applied.

When the variation operation is an analysis transform operation, the corresponding variation operation is a synthesis transform operation.

In some embodiments, the encoding device may further perform an entropy coding operation on the fundamental decoded bitstream. When the encoding device determines M encoded bitstream(s), the entropy coding operation may also be performed on the M encoded bitstream(s). Correspondingly, the decoding device may perform an entropy decoding operation first and then perform the decoding operation. The entropy coding operation may be an arithmetic coding, or, other types of entropy coding like a range coding, Huffman coding, Asymmetric numeral systems (ANS) can be used instead of arithmetic coding.

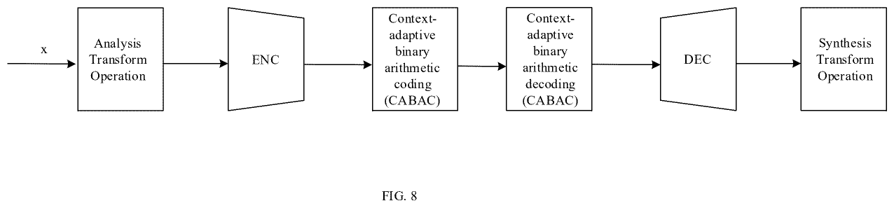

FIG. 8 illustrates an encoding-decoding procedure according to some embodiments of the present application.

Referring to FIG. 8, the encoding device may perform context-adaptive binary arithmetic coding (CABAC) on the encoded bitstream to obtain an arithmetic encoded bitstream. The decoding device may receive the arithmetic encoded bitstream, performs context-adaptive binary arithmetic decoding (CABAC) on the arithmetic encoded bitstream to obtain the encoded bitstream, and performs the decoding operation on the fundamental encoded bitstream.

As previously mentioned, the encoding device may further transmit some decoding information to the decoding device. In some embodiments, the encoding device may also perform the arithmetic coding operation on the decoding information and transmit the encoded decoding information to the decoding device. Correspondingly, the decoding device may perform the arithmetic decoding operation on the received encoded decoding information.

In some embodiments, before performing the entropy coding operation, the encoding device may first input the fundamental encoded bitstream to an optimization model to obtain an optimized parameter. When the encoding device generates M encoded bitstream(s), the M encoded bitstream(s) may also be inputted to the optimization model. Then, the entropy coding operation may be performed on the encoded bitstream based on the optimized parameter.

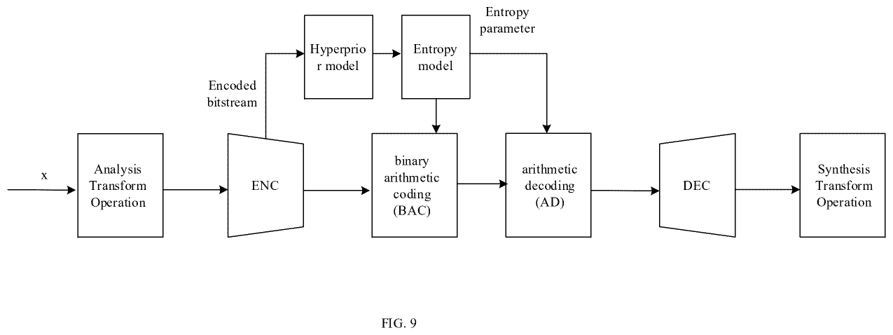

FIG. 9 illustrates an encoding-decoding procedure according to some embodiments of the present application.

Referring to FIG. 9, the encoded bitstream may be inputted to a hyperpior model (or hyperprior network), output of the hyper prior model is inputted to an entropy model, and output of the entropy model is an entropy parameter (that is, the optimized parameter). Then, the encoding device performs a binary arithmetic coding (BAC) on the encoded bitstream according to the entropy parameter to obtain an arithmetic encoded bitstream and transmits the arithmetic encoded bitstream to the decoding device. The entropy parameter may be transmitted to the decoding device. The decoding device receives the arithmetic encoded bitstream and the entropy parameter, performs binary arithmetic decoding on the arithmetic encoded bit stream according to the entropy parameter to obtain encoding bitstream, and performs the decoding operation on the encoding bitstream.

FIG. 9 illustrates a procedure for optimizing the fundamental encoded bitstream. The procedure for optimizing the M encoded bitstream(s) is similar to FIG. 9 and will refrain from elaborating further for the sake of brevity.

FIG. 10 illustrates a decoding method according to some embodiments of the present application. For convenience, it is assumed that the operation illustrated in FIG. 10 is performed by a decoder or a decoding device. However, it should be understood that the operation illustrated in FIG. 10 may also be performed by a component of the decoder/decoding device, such as a circuit in the decoder/decoding device, or a chip or a SoC in the decoder/decoding device. As previously mentioned, the procedure for obtaining the encoded bitstream may also include the decoding operation. Therefore, the method illustrated in FIG. 10 may also be performed by the encoder/encoding device or a component in the encoder/encoding device.

1001, The decoding device acquiring a bitstream D₀.

1002, The decoding device determines a reconstructed feature tensor \hat{z}₀ according to the bitstream D₀.

1003, The decoding device performs a decoding operation on the reconstructed feature tensor \hat{z}₀ to obtain a reconstructed latent representation ŷ₀ by using a neural network. The neural network may be the previously mentioned DEC NN.

1004, The decoding device performs a synthesis transform operation based on the reconstructed latent representation ŷ₀ to generate a reconstructed signal \hat{x}.

In some other embodiments, the decoding device may receive a decoding information from the encoding device, and the reconstructed feature tensor \hat{z}₀ may be determined according to the bitstream D₀ and the decoding information.

In some embodiments, the decoding information may include a length tensor N_{bits0}. The decoding device may determine an index tensor idx₀ according to the dimensional parameter N_{max_0}. For example, the index tensor idx₀ may be filled continuously with values from 0 to N_{max_0}. Then, the decoding device may determine a mask tensor MSK₀ according to the length tensor N_{bits0} and the index tensor idx₀. The decoding device employs the same approach as the encoding device to determine the mask tensor MSK₀ according to the length tensor N_{bits0} and the index tensor idx₀. For the sake of brevity, it will not be retreated here.

In some other embodiments, the decoding information may include the length tensor N_{bits0} and the index tensor idx₀. Under this condition, the decoding device do not need to determine the index tensor idx₀ by itself.

In some other embodiments, the decoding information may include the mask tensor MSK₀. In other words, the decoding device may directly receive the mask tensor MSK₀ from the encoding device.

The bitstream D₀ may include X₁ bits, and the mask tensor MSK₀ includes X elements, where the X elements include X₁ first element with a first value and X₂ second element with a second value. X₁ and X₂ are positive integer, and a sum of X₁ and X₂ is equal to X.

The size of the encoded bitstream D₀ is less than a size of the reconstructed feature tensor \hat{z}₀, and the size of the reconstructed feature tensor \hat{z}₀ is the same as the size of the mask tensor MSK₀. As previously mentioned, if the size of the bitstream D₀ is X₁ and the size of the mask tensor MSK₀ is X, then the size of the reconstructed feature tensor \hat{z}₀ may be X. In other words, the reconstructed feature tensor \hat{z}₀ may include X elements. The X elements includes X₁ third element and X₂ fourth elements. The X₁ third elements are in one-to-one correspondence with the X₁ first elements in the mask tensor MSK₀. Meanwhile, the X₂ fourth elements are in one-to-one correspondence with the X₂ second elements in the mask tensor MSK₀. A location of each of the X₁ third elements is the same as a location of a corresponding first elements, and a location of each of the X₂ fourth elements is the same as a location of a corresponding second element. For example, if the first value is 1, the second value is 0, and

$${MSK}_{0} = ( \begin{matrix}1 & 1 & 0 \\ 0 & 0 & 0 \\ 1 & 1 & 1\end{matrix} ) ,$$

then

$${\hat{z}}_{0} = ( \begin{matrix}α & α & β \\ β & β & β \\ α & α & α\end{matrix} ) ,$$

where α denotes the third element, and β denotes the fourth element. Further, the X₁ third elements are in one-to-one correspondence with X₁ bits in the encoded bitstream, and a value of each of the X₁ third elements is the same as a value of the corresponding bit. A value of each of the fourth elements is a present value which is different from the first value. For example, if D₀=01100 and the preset value is 0, then

$${\hat{z}}_{0} = ( \begin{matrix}0 & 1 & 0 \\ 0 & 0 & 0 \\ 1 & 0 & 0\end{matrix} ) .$$

The preset value 0 is merely an example of the first value. In some other embodiments, the preset value may be any other value. Further, in some embodiments, values of different fourth elements may be different.

After obtaining the reconstructed feature tensor \hat{z}₀, the encoding device may determine a reconstructed latent representation ŷ₀ corresponding to the reconstructed feature tensor \hat{z}₀, and then perform the synthesis transform on the reconstructed latent representation ŷ₀ to obtain the reconstructed signal \hat{x}.

As previously mentioned, in some embodiments, in addition to the fundamental datastream information (that is the datastream information including the fundamental encoded bitstream D₀ and the fundamental decoding information), the encoding device may determine M piece(s) of datastream information and transmit the M piece(s) of datastream information to the decoding device. Correspondingly, the decoding device may receive the M piece(s) of datastream information and determine the reconstructed signal \hat{x}. according to the M piece(s) of datastream information and the fundamental datastream information.

Each of the M piece(s) of datastream information may include an encoded bitstream. Therefore, the decoding device may obtain M encoded bitstream(s).

The decoding device may perform M decoding operation(s) on the M encoded bitstream(s) to obtain M reconstructed latent representation. Then the decoding device may determine the reconstructed signal \hat{x}. according to the reconstructed latent representation ŷ₀ and the M reconstructed latent representation.

Similarly, each of the M piece(s) of datastream information may further include a decoding information corresponding to the encoded bitstream. The decoding information corresponding to the encoded bitstream include information for decoding the encoded bitstream. Details of the relationship between the encoded bitstream and the decoding information included in the datastream information may referred to the aforementioned encoded bitstream and the decoding information, and details for performing each of the M decoding operation(s) may refer to previously mentioned embodiments and it will not be retreated here.

In some embodiments, the decoding device may perform a synthesis transform operation on each of the reconstructed latent representation ŷ₀ and the M reconstructed latent representation to obtain M+1 synthesis transformation results and determine the reconstructed signal \hat{x}. according to the M+1 synthesis transformation results.

FIG. 11 illustrates a decoding procedure according to some embodiments of the present application.

Referring to FIG. 11, the fundamental datastream information obtained from the encoding device is denoted by bits₀, a first datastream information among the M piece(s) of datastream information is denoted by bits₁, a second datastream information among the M piece(s) of datastream information is denoted by bits₂, and so forth. A decoding procedure performed on bits₀ may be referred to as a decoding procedure #0, a decoding procedure performed on bits₁ may be referred to as a decoding procedure #1, and so forth. In FIG. 11, the decoding procedure #0 includes a decoding operation #0 denoted by DEC₀ and a corresponding synthesis transform #0 denoted by S₀, the decoding procedure #1 includes a decoding operation #1 denoted by DEC₁ and a corresponding synthesis transform #1 denoted by S₁, and so forth. As previously mentioned, each of the decoding operation has a corresponding tensor reconstructing operation. The decoding operation is performed on the result of the corresponding tensor reconstructing operation. However, FIG. 11 does not show the tensor reconstructing operation for brevity.

In FIG. 11, output of the decoding procedure #0 is denoted by rec₀, output of the decoding procedure #1 is denoted by rec₁, and so forth. The reconstructed signal \hat{x} is a sum of outputs of the M+1 decoding procedure. In other words, the reconstructed signal \hat{x} and the output of the M+1 decoding procedures satisfy:

rec=rec₀+rec₁+rec₂+ . . . +rec_{M}, (3.1)

where rec=\hat{x}, that is the reconstructed data.

The decoding procedure illustrated in FIG. 11 corresponds to the encoding procedure illustrated in FIG. 5. In other words, the datastream information (that is, bits₀ to bits_{M}) are results of the encoding procedure illustrated in FIG. 5.

In some other embodiments, the decoding device may perform M+1 decoding operations and M+1 synthesis transform operations. The M+1 synthesis transform operations are performed on M+1 reference information and the reconstructed data is an output of the M+1^{th} synthesis transformation. A first reference information among the M+1 reference information is the reconstructed latent representation ŷ₀, a m+1^{th} reference information is determined according to a m^{th} transformed information and a m^{th} reconstructed latent representation ŷₘ, the m^{th} transformed information is determined according to a synthesis transformation result of a m^{th} synthesis transform operation among the M+1 synthesis transform operations, and the reconstructed signal \hat{x}.

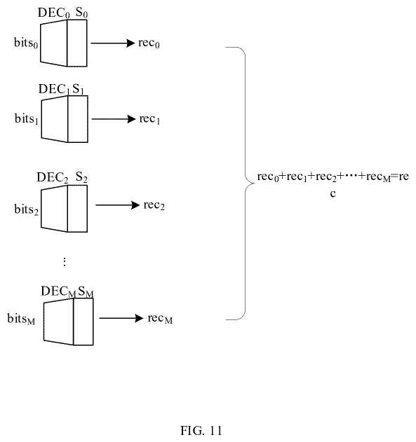

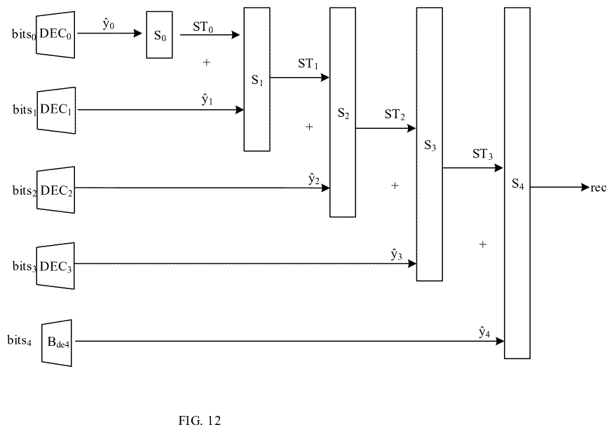

FIG. 12 illustrates a decoding procedure according to some embodiments of the present application. Similar to the abovementioned embodiments, ENC illustrated in FIG. 12 represents an encoding operation and a bitstream deriving operation corresponding to the encoding operation, and DEC illustrated in FIG. 12 represents a decoding operation and a tensor reconstructing operation corresponding to the decoding operation.

FIG. 12 illustrates 5 DECs (that is, DEC₀ to DEC₄ illustrated in FIG. 12) and 5 synthesis transform operations (that is, S₀ to S₄ illustrates in FIG. 12). DEC₀ is performed based on the fundamental datastream information (denoted by bits₀ in FIG. 12), and ŷ₀ is the reconstructed latent representation determined by DEC₀. In FIG. 12, four datastream information obtained from the encoding device are denoted by bits₁ to bits₄, and ŷ₁ to ŷ₄ are four reconstructed latent representations determined by DEC₁ to DEC₄ respectively. The synthesis transformation results of S₀ to S₃ are denoted by ST₀ to ST₃.

Referring to FIG. 12, the first reference information is the input of S₀, which is ŷ₀. The second reference information is the input of S₁, and the second reference information is determined according to ST₀ and ŷ₁. For example, the second reference information is a sum of ST₀ and ŷ₁. Similarly, the second reference information, the input of S₁, is determined according to ST₁ and ŷ₂, and so forth. The synthesis transformation result of S₄ is the reconstructed signal (denoted by rec in FIG. 12).

In some embodiments, bits₀ to bits₄ illustrated in FIG. 12 may be determined according to the encoding procedure illustrated in FIG. 7. In other words, bits₀ to bits₄ illustrated in FIG. 12 are bits₀ to bits₄ illustrated in FIG. 7.

In some embodiments, a variation operation may be performed on the reconstructed latent representation ŷ₀ and/or at least one of the M reconstructed latent representation. For convenience, a term “first reconstructed latent representation” may be referred to a reconstructed latent representation among M+1 reconstructed latent representation (that is, the reconstructed latent representation ŷ₀ and the M reconstructed latent representation) on which the variation operation is performed, and a term “second reconstructed latent representation” may be referred to a reconstructed latent representation among M+1 reconstructed latent representation on which the variation operation is not performed. Correspondingly, the decoding operation that is used to generate the first reconstructed latent representation may be referred to as “first decoding operation”, and the term “second decoding operation” may be referred to the decoding operation on which the corresponding variation operation is not performed.

As previously mentioned, the synthesis transform operation may be performed on the reconstructed latent representation ŷ₀ and/or the M reconstructed latent representation. When a reconstructed latent representation is the first reconstructed latent representation, the synthesis transform operation may be performed a varied reconstructed latent representation, the varied reconstructed latent representation is a result of the variation operation performed on the first reconstructed latent representation. When a reconstructed latent representation is the second reconstructed latent representation, the synthesis transform operation is performed on the second reconstructed latent representation.

The reconstructed latent representation is obtained by decoding the encoded bitstream by the decoding operation. If an encoded bitstream among M+1 encoded bitstream (that is, the encoded bitstream D₀ and the M encoded bitstream(s)) is performed by the first decoding operation, the encoded bitstream may be referred to as a first encoded bitstream; if an encoded bitstream among the M+1 encoded bitstream is not performed by the first decoding operation, the encoded bitstream may be referred to as a second encoded bitstream. Correspondingly, an encoding operation for determining the first encoded bitstream may be referred to as a first encoding operation, and an encoding operation for determining the second encoded bitstream may be referred to as a second encoding operation. Further, an input data of the first encoding operation may be referred to as a first input data, and an input data of the second encoding operation may be referred to as a second input data. The encoding device performs a corresponding variation operation on the first input data to obtain a varied input data, and then performs the first encoding on the varied input data. As previously mentioned, the encoding device may perform the first variation and the second variation. Details about the first variation and the second variation may refer to the previous embodiments, and will not be described here. For convenience, the variation operation performed by the decoding device may be referred to as a third variation operation. The third variation operation is an inverse operation of the first variation operation. For example, when the first variation operation is a down-sampling operation, the third variation operation is an up-sampling operation; when the first variation operation is an up-sampling operation, the third variation operation is n down-sampling operation.

In some other embodiments, the decoding device may determine a reference reconstructed latent representation, and then perform a synthesis transform operation on the reference reconstructed latent representation to obtain the reconstructed signal, where the reconstructed signal is a result of the synthesis transform operation. The reference reconstructed latent representation may a sum of the reconstructed latent representation ŷ₀ and the M reconstructed latent representation. In other words, the reference reconstructed latent representation, the reconstructed latent representation ŷ₀ and the M reconstructed latent representation satisfy:

ŷ_{ref}=ŷ₀+ŷ₁+ŷ₂+ . . . +ŷ_{M}, (3.2)

where ŷ_{ref} is the reference reconstructed latent representation, ŷ₀ is the reconstructed latent representation, ŷₘ is a m^{th} reconstructed latent representation among the M reconstructed latent representation, m=1, . . . , M.

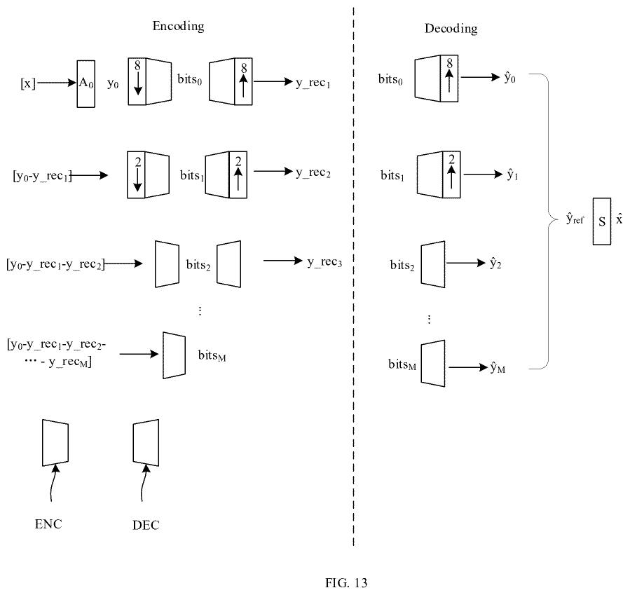

FIG. 13 illustrates an encoding procedure and a corresponding decoding procedure according to some embodiments of the present application. The definition of the abbreviations and notations in FIG. 13 may be referred to the aforementioned embodiments. Similar to the previously mentioned embodiments, FIG. 13 omits the bitstream deriving operation and the tensor reconstructing operation. Similar to the abovementioned embodiments, ENC illustrated in FIG. 13 represents an encoding operation and a bitstream deriving operation corresponding to the encoding operation, and DEC illustrated in FIG. 13 represents a decoding operation and a tensor reconstructing operation corresponding to the decoding operation.

Referring to FIG. 13, in order to obtain bits₀, the encoding device performs a downing sampling operation before performing the encoding operation that is used to obtain bits₀. Similarly, the encoding device performs a down-sampling operation before performing the encoding operation that is used to obtain bits₁. For bits₂ to bits_{M}, the encoding device do not perform a variation operation. For the encoding procedure, the encoding device performs an up-sampling operation on an output of a decoding operation used to decode bits₀ and performs an up-sampling operation on an output of a decoding operation used to decode bits₁. For decoding operation for decoding bits₂ to bits_{M}, the encoding device does not perform a variation operation on outputs of these operations.

For the decoding procedure, the decoding device performs an up-sampling operation on a decoding operation that is used to decode bits₀ and performs an up-sampling operation on a decoding operation that is used to decode bits₁. For decoding operation for decoding bits₂ to bits_{M}, the decoding device does not perform a variation operation on outputs of these operations. In addition, the decoding device determines the reference reconstructed latent representation ŷ_{ref} according to ŷ₀ to ŷ_{M} and performs a synthesis transform operation on the reference reconstructed latent representation ŷ_{ref} to obtain a reconstructed signal \hat{x} (e.g., a reconstructed image or a reconstructed image).

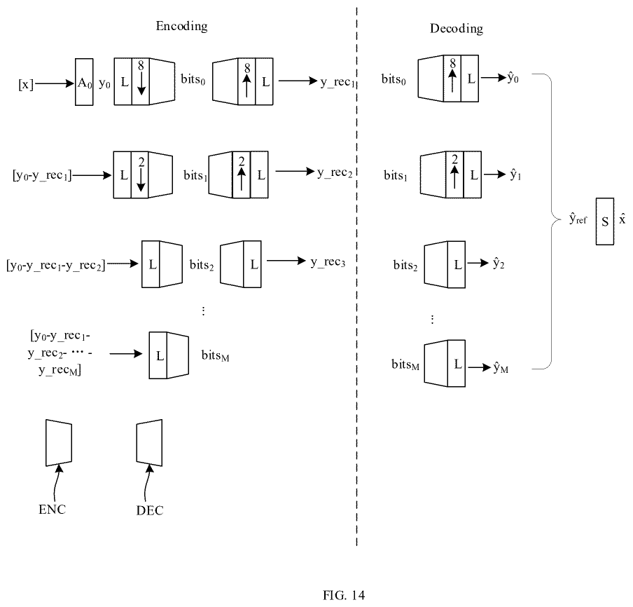

FIG. 14 illustrates an encoding procedure and a corresponding decoding procedure according to some embodiments of the present application. The definition of the abbreviations and notations in FIG. 14 may be referred to the aforementioned embodiments. “L” in FIG. 14 denotes a linear transformation.

Similar to the embodiment illustrated in FIG. 13, an encoding device performs a down-sampling operation before performing an encoding operation for obtaining bits₀ and bits₁ and performs an up-sampling operation on results of a decoding operation performed on bits₀ and bits₂. In addition, the encoding device performs a linear transformation. For bits₀ and bits₁, the linear transformation is performed before the down-sampling operation and after the up-sampling operation. For bits₂ to bits_{M}, the linear transformation is performed before the encoding operation and after the decoding operation. Similarly, the decoding device further performs a linear transformation. For bits₀ and bits₁, the linear transformation is performed after the up-sampling operation. For bits₂ to bits_{M}, the linear transformation is performed after the decoding operation.

A loss function according to some embodiments of the present application may be the following equation:

$$Loss = \frac{{\sum }_{i} {N}_{bits \_ i}}{W \times H} + β * MSE ( \hat{x} , x ) , \qquad ( 4.1 )$$

where W×H is a shape of the pre-coding data (that is, a input image of the encoding device), N_{bits_i} denotes to the number of bits (channels to use) in i-th row of the latent vector y (which size is equal to batches_number×rows_number×channels_number), β value denotes desired ration between both losses. The larger is β, the larger is distortion importance, and by thus, more bits will be used. For example, during a training procedure β may be changing from 0² to 80² (float number), and from 10², 20², 30₂, . . . , 80² (integer number) on an evaluation procedure. A distortion metrics of the loss function in equation 4.1 is mean square error (MSE), and MSE_{(\hat{x},x)} is an average of squares of the differences between a predicted value x̅ and a true value x, where the predicted value \hat{x}. is a reconstructed signal determined by a decoding procedure according to the encoded bitstream determined by the encoding device, and the true value x is the input data of the encoding procedure.

For the embodiments illustrated in FIG. 11, the loss function may be:

$$Loss ( β ) = {\sum }_{i = 0}^{M} {bits}_{i} ( β ) + β * distortion ( x , {\sum }_{i = 0}^{M} {rec}_{i} ( β ) ) , \qquad ( 4.2 )$$

where bitsᵢ(β) denotes number of bits of the encoded bitstream obtained by B_{dci}, and recᵢ(β) denotes number of bits of the output of the decoding operation #i. β represents a balance between rate and distortion in loss function.

$$distortion ( x , {\sum }_{i = 0}^{M} {rec}_{i} ( β ) )$$

is a distortion metrics between x and

$${\sum }_{i = 0}^{M} {rec}_{i} ( β ) ,$$

and x is the pre-coding data. The distortion metrics may be MSE, multi-scale structural similarity (MS-SSIM), structural similarity (SSIM) or the like.

Equation 4.3 shows MSE distortion with weights 8:1:1 over aYUV image:

Distortion(A, B)=0.8*MSE(A.Y, B.Y)+0.1*MSE(A.U, B.U)+0.1*MSE(A.V, B.V) (4.3)

A, B are samples for the distortion evaluation.

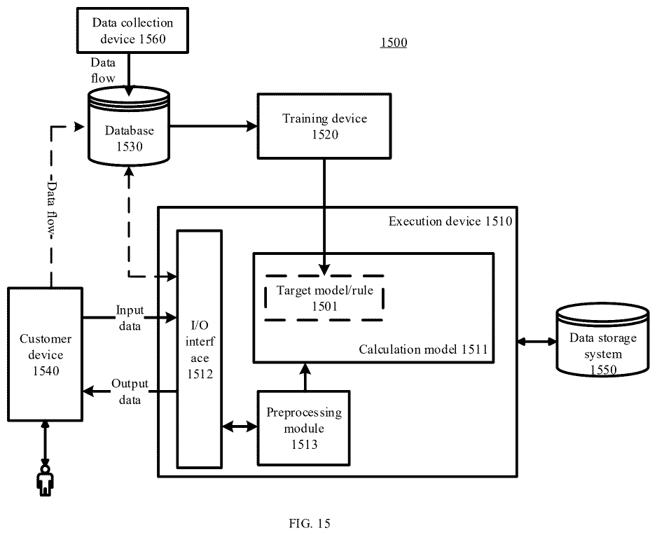

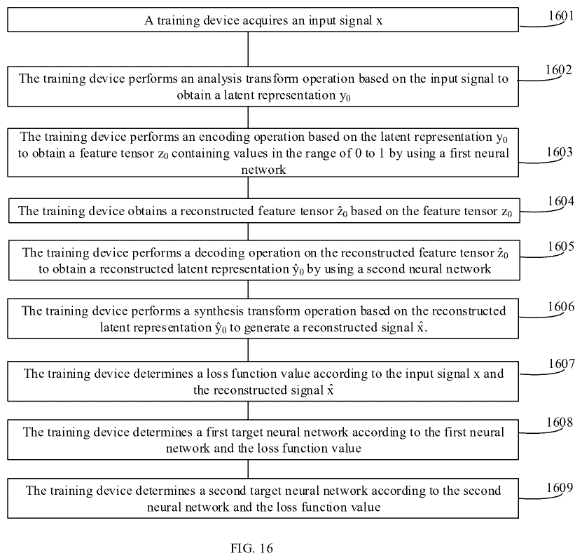

The above-mentioned loss function may be used to train the ENC NN and the DEC NN. FIG. 15 and FIG. 16 are used to depict the training procedure of the ENC NN and the DEC NN.

Referring to FIG. 15, an embodiment of the present application provides a system architecture 1500. As shown in the system architecture 1500, a data collection device 1560 is configured to collect training data. The training data may be stored into a database 1530. A training device 1520 may obtain a target model/rule 1501 through training based on the training data maintained in the database 1530. In some embodiments, the target model/rule 1501 can be used to implement the ENC NN to obtain the feature tensor. In some other embodiments, the target model/rule 1501 can be used to implement the DEC NN to obtain the reconstructed latent representation. The target model/rule 1501 in this embodiment of this application may specifically be a neural network obtained through training. In this embodiment provided in this application, the neural network is obtained by training an initialized neural network. It should be noted that, in actual application, the training data maintained in the database 1530 is not necessarily all collected by the data collection device 1560, and may be received from another device. In addition, it should be noted that the training device 1520 does not necessarily perform training completely based on the training data maintained in the database 1530 to obtain the target model/rule 1501, and may obtain training data from a cloud or another place to perform model training. The foregoing description shall not be construed as a limitation on this embodiment of this application.

The target model/rule 1501 obtained by the training device 1520 through training may be applied to different systems or devices, for example, applied to an execution device 1510 shown in FIG. 15. The execution device 1510 may be a terminal, such as a mobile phone terminal, a tablet computer, a notebook computer, an augmented reality (AR) device, a virtual reality (VR) device, or a vehicle-mounted terminal, or may be a server or the like. In FIG. 15, an I/O interface 1512 is configured on the execution device 1510 and is configured to exchange data with an external device. A user may input data into the I/O interface 1512 by using a customer device 1540. The input data may be data collected by the execution device 1510 by using the data collection device 1560, may be data in the database 1530, or may be data from the customer device 1540. The input data may be an image, a video frame, an audio data, a text data or the like, and the present application is not limited thereto.

A preprocessing module 1513 is configured to perform preprocessing based on the input data (for example, the input image) received by the I/O interface 1512. For example, the preprocessing module 1513 may be configured to implement one or more of the following operations: flipping, rotation, scaling, grayscale conversion, demozaicking, color correction, lens shading correction, auto white balance and the like; and is further configured to implement another preprocessing operation. This is not limited in this application.

In a related processing procedure in which the execution device 1510 preprocesses the input data or a calculation module 1511 of the execution device 1510 performs calculation, the execution device 1510 may invoke data, code, and the like in a data storage system 1550 to implement corresponding processing, and may also store, into the data storage system 1550, data, an instruction, and the like obtained through corresponding processing.

Finally, the I/O interface 1512 returns a processing result, for example, the foregoing obtained image processing result, to the customer device 1540, to provide the processing result for the user.

It should be noted that the training device 1520 may obtain, through training based on different training data, corresponding target models/rules 1501 for different targets that are alternatively referred to as different tasks. The corresponding target models/rules 1501 may be used to implement the foregoing targets or complete the foregoing tasks, to provide a required result for the user.

In a case shown in FIG. 15, the user may manually provide the input data. The manually providing may be performed by using a screen provided on the I/O interface 1512. In another case, the customer device 1540 may automatically send the input data to the I/O interface 1512. If it is required that the customer device 1540 needs to obtain authorization from the user to automatically send the input data, the user may set corresponding permission on the customer device 1540. The user may view, on the customer device 1540, a result output by the execution device 1510. Specifically, the result may be displayed or may be presented in a form of sound, an action, or the like. The customer device 1540 may also be used as a data collection end to collect the input data that is input into the I/O interface 1512 and an output result that is output from the I/O interface 1512, as shown in the figure, use the input data and the output result as new sample data, and store the new sample data into the database 1530. Certainly, alternatively, the customer device 1540 may not perform collection, and the I/O interface 1512 directly stores, into the database 1530 as new sample data, the input data that is input into the I/O interface 1512 and an output result that is output from the I/O interface 1512, as shown in the figure.

It should be noted that FIG. 15 is merely a schematic diagram of a system architecture provided in an embodiment of the present application. A location relationship between a device, a component, a module, and the like shown in the figure constitutes no limitation. For example, in FIG. 15, the data storage system 1550 is an external memory relative to the execution device 1510. In another case, the data storage system 1550 may be alternatively disposed in the execution device 1510. In this application, the target model/rule 1501 obtained through training based on the training data may be a neural network used for performing the aforementioned encoding/decoding operation.

FIG. 16 illustrates a training method according to some embodiments of the present application. The method illustrated in FIG. 16 is used for training the ENC NN and the DEC NN.

At operation 1601, A training device acquires an input signal x.

At operation 1602, The training device performs an analysis transform operation based on the input signal to obtain a latent representation y₀.

At operation 1603, The training device performs an encoding operation based on the latent representation y₀ to obtain a feature tensor z₀ containing values in the range of 0 to 1 by using a first neural network.

At operation 1604, The training device obtains a reconstructed feature tensor \hat{z}₀ based on the feature tensor z₀.

At operation 1605, The training device performs a decoding operation on the reconstructed feature tensor \hat{z}₀ to obtain a reconstructed latent representation ŷ₀ by using a second neural network.

At operation 1606, The training device performs a synthesis transform operation based on the reconstructed latent representation ŷ₀ to generate a reconstructed signal \hat{x}.

At operation 1607, The training device determines a loss function value according to the input signal x and the reconstructed signal \hat{x}.

At operation 1608, The training device determines a first target neural network according to the first neural network and the loss function value.

At operation 1609, The training device determines a second target neural network according to the second neural network and the loss function value.

The first target neural network is the ENC NN, and the second target neural network is the DEC NN.

In some embodiments, the training device may assign the reconstructed feature tensor \hat{z}₀ equal to the feature tensor z₀.

In some embodiments, the training device may distort at least one element of the feature tensor z₀ before obtaining the reconstructed feature tensor \hat{z}₀. For example, in some embodiment, the training device may invert 0 to 1 and 1 to 0. Inverting 0 to 1 and 1 to 0 simulates bit errors and/or packet losses. Therefore, the first neural network and the second neural network are trained with noise. Consequently, the first neural network and the second neural network may be tolerant to errors, distortions and losses in communication channel.

Equation 5.1 is used to guarantee that the dropping of bits with index larger than N_{bits0}.

z̅=z̅*B(γ[N_{bits}−idx]), (equation 5.1)

where B( ) represents a binarization function. γ is hyper parameter responsible for the binarization function B sharpness. For example, in the beginning of training the binarization function may be softer that can be achieved by making γ is smaller, e.g. 0.01. With increasing number of training epochs y may be increased e.g. up to 1 or 2. For example, in some embodiments, the binarization function B may satisfy:

B=sigmoid(γ[N_{bits}−idx]), (equation 5.2).

Further, during the training process, the binary function for obtaining the binary feature tensor z₀ and the feature tensor z₀ may satisfy:

z̅₀=z̅₀′+δ, (equation 5.3),
where z̅₀′ satisfies equation 5.4, and δ satisfies equation 5.5.

z̅₀′=sigmoid(z₀+∂), (equation 5.4).

δ=round(detach(z̅₀′))−detach (z̅₀′), (equation 5.5)

where ∂ is an optional noise addition. For example, ∂=0.5*U(−1, 1), where U(−1,1) means random variable uniformly distributed from −1 to 1, emulating effect of round operation during training stage. By default ∂=0. Addition of δ allows to keep gradients unaffected, thought values in tensor z̅₀ are strictly binary. detach(z̅₀′) refers to obtain a new tensor detached from z̅₀′.

The present application provides a NN based video, image, audio codecs—source codecs (which are focused only on data compression), channel codecs ((which are focused only on data transmission) and joint source channel coding (which are focused both on data compression and transmission). The NN is used to encode and decode the input data into bitstream. Different features of the input data are compressed to different number of bits (‘words’).

The present application allows to get trainable error tolerant data coding, or NN based data encryption system. The most obvious applications may include real time communication and video streaming systems, such as online meetings and video transmission, such as from phone to TV, from computer to projector, from drone to VR glasses and so on.

The NN may learn their own encoding/decoding way of latent space features represented as floats or integers to binary representation for sending via communication channel, find some correlations, and use less bits to encode data. Further, the ENC NN and the DEC NN may be end to end train together with noise—simulating both bit errors and packet losses—thus, becoming tolerant to errors, distortions and losses in communication channel.

Compared with conventional entropy encoding solutions, the NN based encoding solution provided by the present application have less complexity and less encoding/decoding time due to massive parallel processing on NN supporting hardware. Finally, the present application works in digital domain and do not making any constrains to physical layer having friendly design to existing widely deployed digital communication infrastructure. Therefore, the present application may be deployed with existing hardware (such as routers, Wi-Fi access points, 3G/4G/5G wireless communication devices).

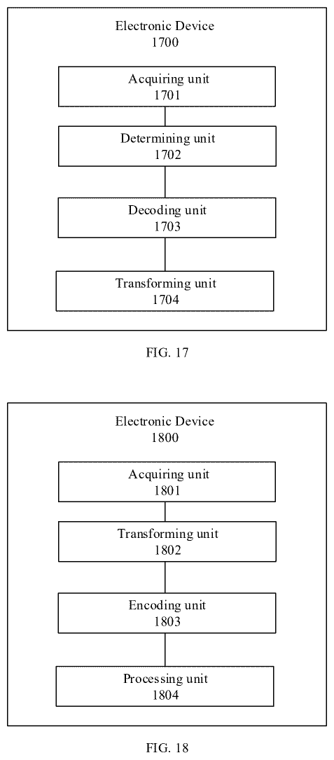

FIG. 17 is a schematic block diagram of an electronic device 1700 according to some embodiments of the present application. The electronic device 1700 may be the aforementioned decoding device. Referring to FIG. 17, the electronic device 1700 includes an acquiring unit 1701, a determining unit 1702, a decoding unit 1703, and a transforming unit 1704.

The acquiring unit 1701 may be configured to acquire a bitstream D₀.

The determining unit 1702 may be configured to determine a reconstructed feature tensor 20 according to the bitstream D₀.

The decoding unit 1703 may be configured to perform a decoding operation on the reconstructed feature tensor \hat{z}₀ to obtain a reconstructed latent representation ŷ₀ by using a neural network.

The transforming unit 1704 may be configured to performing a synthesis transform operation based on the reconstructed latent representation ŷ₀ to generate a reconstructed signal \hat{x}.

The determining unit 1702, the decoding unit 1703, and the transforming unit 1704 may be implemented by a processor. In some embodiments, the determining unit 1702, the decoding unit 1703 and the transforming unit 1704 may be implemented by the one processor. In some other embodiments, the determining unit 1702, the decoding unit 1703, and the transforming unit 1704 may be implemented by two or more processors. In some embodiments, the acquiring unit 1701 may be implemented by a receiver or a receiving circuit of the processor.

Details on how to decode the acquired bitstream D₀ may refer to the above-mentioned embodiments and will not be described here.

FIG. 18 is a schematic block diagram of an electronic device 1800 according to some embodiments of the present application. The electronic device 1800 may be the aforementioned encoding device. Referring to FIG. 18, the electronic device 1800 includes an acquiring unit 1801, a transforming unit 1802, an encoding unit 1803, and a processing unit 1804.

The acquiring unit 1801 may be configured to acquire an input signal.

The transforming unit 1802 may be configured to perform an analysis transform operation based on the input signal to obtain a latent representation y₀.

The encoding unit 1803 may be configured to perform an encoding operation based on the latent representation y₀ to obtain a feature tensor z0 by using a neural network.

The processing unit 1804 may be configured to generating a bitstream D₀ according to the feature tensor z₀.

The transforming unit 1802, the encoding unit 1803, and the processing unit 1804 may be implemented by a processor. In some embodiments, the transforming unit 1802, the encoding unit 1803, and the processing unit 1804 may be implemented by the one processor. In some other embodiments, the transforming unit 1802, the encoding unit 1803, and the processing unit 1804 may be implemented by two or more processors. The acquiring unit 1801 may be implemented by a receiver or a receiving circuit of the processor.

Details on how to encode the input signal may refer to the above-mentioned embodiments and will not be described here.

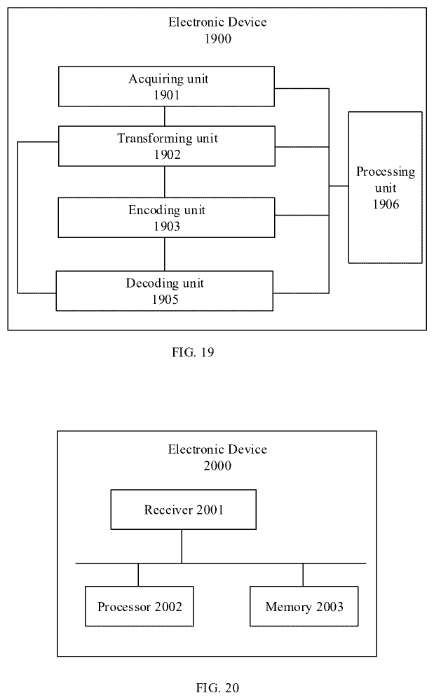

FIG. 19 is a schematic block diagram of an electronic device 1900 according to some embodiments of the present application. The electronic device 1900 may be aforementioned training device. Referring to FIG. 19, the electronic device 1900 includes an acquiring unit 1901, a transforming unit 1902, an encoding unit 1903, an obtaining unit 1904, a decoding unit 1905, and a processing unit 1906.

The acquiring unit 1901 may be configured to acquire an input signal x.

The transforming unit 1902, may be configured to perform an analysis transform operation based on the input signal to obtain a latent representation y₀.

The encoding unit 1903 may be configured to perform an encoding operation based on the latent representation y₀ to obtain a feature tensor z₀ containing values in the range of 0 to 1 by using a first neural network.

The obtaining unit 1904 may be configured to obtain a reconstructed feature tensor \hat{z}₀ based on the feature tensor z₀.

The decoding unit 1905 may be configured to perform a decoding operation on the reconstructed feature tensor \hat{z}₀ to obtain a reconstructed latent representation ŷ₀ by using a second neural network.

The transforming unit 1902 may be further configured to perform a synthesis transform operation based on the reconstructed latent representation ŷ₀ to generate a reconstructed signal \hat{x}.

The processing unit 1906 may be configured to determine a loss function value according to the input signal x and the reconstructed signal \hat{x};

The processing unit 1906 may be further configured to determine a first target neural network according to the first neural network and the loss function value;

The processing unit 1906 may be further configured to determine a second target neural network according to the second neural network and the loss function value.

The transforming unit 1902, the encoding unit 1903, the obtaining unit 1904, the decoding unit 1905, and the processing unit 1906 may be implemented by a processor. In some embodiments, the transforming unit 1902, the encoding unit 1903, the obtaining unit 1904, the decoding unit 1905, and the processing unit 1906 may be implemented by the one processor. In some other embodiments, the transforming unit 1902, the encoding unit 1903, the obtaining unit 1904, the decoding unit 1905, and the processing unit 1906 may be implemented by two or more processors. The acquiring unit 1901 may be implemented by a receiver or a receiving circuit of the processor.

Details on how to train the first neural network and the second network may refer to the above-mentioned embodiments and will not be described here.

As shown in FIG. 20, an electronic device 2000 may include a receiver 2001, a processor 2002, and a memory 2003. The memory 2003 may be configured to store code, instructions, and the like executed by the processor 2002.

It should be understood that the processor 2002 may be an integrated circuit chip and has a signal processing capability. In an implementation process, steps of the foregoing method embodiments may be completed by using a hardware integrated logic circuit in the processor, or by using instructions in a form of software. The processor may be a general purpose processor, a central processing unit (CPU), a graphics processing unit (GPU), a neural processing unit (NPU), a system on chip (SoC) or another programmable logic device, a discrete gate or transistor logic device, or a discrete hardware component. The processor may implement or perform the methods, the steps, and the logical block diagrams that are disclosed in the embodiments of the present application. The general purpose processor may be a microprocessor, or the processor may be any conventional processor or the like. The steps of the methods disclosed with reference to the embodiments of the present application may be directly performed and completed by the processor, or may be performed and completed by using a combination of hardware in the processor and a software module. The software module may be located in a mature storage medium in the art, such as a random access memory, a flash memory, a read-only memory, a programmable read-only memory, an electrically erasable programmable memory, or a register. The storage medium is located in the memory, and the processor reads information in the memory and completes the steps of the foregoing methods performed by the encoding device or the decoding device in combination with hardware in the processor.

It may be understood that the memory 2003 in the embodiments of the present application may be a volatile memory or a nonvolatile memory, or may include both a volatile memory and a nonvolatile memory. The nonvolatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM) and is used as an external cache. By way of example rather than limitation, many forms of RAMs may be used, and are, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (Synchronous link DRAM, SLDRAM), and a direct rambus random access memory (Direct Rambus RAM, DR RAM).

It should be noted that the memory in the electronic device and the methods described in this specification includes but is not limited to these memories and a memory of any other appropriate type.

The present application provides a computer readable storage medium including instructions. When the instructions run on an electronic device, the electronic device is enabled to perform the aforementioned method.

The present application provides a computer readable storage medium. The computer readable storage medium stores the bitstream obtained by the aforementioned method.

The present application provides a chip system. The chip system includes a memory and a processor, and the memory is configured to store a computer program, and the processor is configured to invoke the computer program from the memory and run the computer program, so that an electronic device on which the chip system is disposed performs the aforementioned method.

The present application provides a computer program product. When the computer program product runs on an electronic device, the electronic device is enabled to perform the aforementioned method.

In the embodiments of the present application, “at least one” means one or more, and “a plurality of” means two or more. The term “and/or” describes an association relationship between associated objects and represents that three relationships may exist. For example, A and/or B may represent the following three cases: only A exists, both A and B exist, and only B exists, where A and B may be singular or plural. The character “/” generally indicates an “or” relationship between the associated objects. “At least one of the following” and a similar expression thereof refer to any combination of these items, including any combination of one item or a plurality of items. For example, at least one of a, b, and c may indicate: a, b, c, a and b, a and c, b and c, or a, b, and c, where a, b, and c may be singular or plural.

A person of ordinary skill in the art may be aware that, in combination with the examples described in the embodiments disclosed in this specification, units and algorithm steps can be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiment. Details are not described herein again.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may be or may not be physically separate, and parts displayed as units may be or may not be physical units, may be located in one position, or may be distributed on a plurality of network units. Some or all of the units may be selected based on actual requirements to achieve the objectives of the solutions of the embodiments.

In addition, functional units in the embodiments of this application may be integrated into one processing unit, or each of the units may exist alone physically, or two or more units are integrated into one unit.

When the functions are implemented in a form of a software functional unit and sold or used as an independent product, the functions may be stored in a computer readable storage medium. Based on such an understanding, the technical solutions in this application essentially, or the part contributing to the prior art, or some of the technical solutions may be implemented in a form of a software product. The computer software product is stored in a storage medium, and includes several instructions for instructing a computer device (which may be a personal computer, a server, a network device, or the like) to perform all or some of the steps of the methods described in the embodiments of this application. The foregoing storage medium includes: any medium that can store program code, such as a USB flash drive, a removable hard disk, a read-only memory (Read-Only Memory, ROM), a random access memory (Random Access Memory, RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A decoding method, comprising:
acquiring a bitstream D₀;
determining a reconstructed feature tensor \hat{z}₀ according to the bitstream D₀;
performing a decoding operation on the reconstructed feature tensor \hat{z}₀ to obtain a reconstructed latent representation ŷ₀ by using a neural network; and
performing a synthesis transform operation based on the reconstructed latent representation ŷ₀ to generate a reconstructed signal \hat{x}.

2. The method according to claim 1, wherein the method further comprises:
acquiring a decoding information,
wherein the determining a reconstructed feature tensor \hat{z}₀ according to the bitstream D₀, comprises:
determining the reconstructed feature tensor \hat{z}₀ according to the decoding information and the bitstream D₀, wherein a size of the reconstructed feature tensor \hat{z}₀ is larger than a size of the bitstream D₀.

3. The method according to claim 2, wherein the decoding information is obtained based on information signaled with the bitstream D₀.

4. The method according to claim 2, wherein the decoding information comprises a length tensor N_{bits0}.

5. The method according to claim 4, wherein the determining the reconstructed feature tensor \hat{z}₀ according to the decoding information, comprises:
determining a mask tensor MSK₀ according to the length tensor N_{bits0} and an index tensor idx₀, wherein the bitstream D₀ comprises X₁ bit(s), the mask tensor MSK₀ comprises X₁ first element(s) with a first value and X₂ second element(s) with a second value, a sum of X₁ and X₂ is the size of the reconstructed feature tensor \hat{z}₀, X₁ is a positive integer, X₂ is a positive integer; and
determining the reconstructed feature tensor \hat{z}₀ according to the mask tensor MSK₀ and the bitstream D₀, wherein the reconstructed feature tensor \hat{z}₀ comprises X₁ third element(s) and X₂ fourth element(s), a location of each element in the reconstructed feature tensor \hat{z}₀ is a same as a location of a corresponding element in the mask tensor MSK₀, a value of each of the X₁ third element(s) is a same as a value of a corresponding bit in the bitstream D₀, and a value of each of the X₂ fourth element(s) is a preset value that is not equals to 1.

6. The method according to claim 1, wherein the method further comprises:
acquiring M bitstream(s), wherein M is a positive integer;
determining M reconstructed feature tensor(s) according to the M bitstream(s) respectively; and
performing M decoding operation(s) on the M reconstructed feature tensor(s) to obtain M reconstructed latent representation(s);
wherein the performing a synthesis transform operation based on the reconstructed latent representation ŷ₀ to generate a reconstructed signal \hat{x}, comprises:
performing the synthesis transform operation based on the reconstructed latent representation y̅₀ and the M reconstructed latent representation(s) to generate the reconstructed signal \hat{x}.

7. The method according to claim 6, wherein the performing the synthesis transform operation based on the reconstructed latent representation ŷ₀ and the M reconstructed latent representation(s) to generate the reconstructed signal \hat{x}, comprises:
performing the synthesis transform operation on each of the reconstructed latent representation ŷ₀ and the M reconstructed latent representation(s) to obtain M+1 synthesis transform results; and
generating the reconstructed signal \hat{x} according to the M+1 synthesis transformation results.

8. The method according to claim 6, wherein the performing the synthesis transform operation base on the reconstructed latent representation ŷ₀ and the M reconstructed latent representation(s) to generate the reconstructed signal \hat{x}, comprises:
determining a reference reconstructed latent representation, wherein the reference reconstructed latent representation is a sum of the reconstructed latent representation ŷ₀ and the M reconstructed latent representation(s); and
performing the synthesis transform operation on the reference reconstructed latent representation to generate the reconstructed signal \hat{x}.

9. The method according to claim 6, wherein the performing the synthesis transform operation based on the reconstructed latent representation ŷ₀ and the M reconstructed latent representation(s) to generate the reconstructed signal \hat{x}, comprises:
performing M+1 synthesis transform operations on M+1 reference information to generate the reconstructed signal \hat{x}, wherein a first reference information among the M+1 reference information is the reconstructed latent representation ŷ₀, a m+1^{th} reference information is determined according to a m^{th} transformed information and a m^{th} reconstructed latent representation, the m^{th} transformed information is determined according to a synthesis transformation result of a m^{th} synthesis transform operation among the M+1 synthesis transform operations.

10. The method according to claim 7, wherein the method further comprises:
performing a variation operation on a reference reconstructed latent representation, wherein the reference reconstructed latent representation is a reconstructed latent representation determined by a reference decoding operation, the reference decoding operation is the decoding operation or one of the M decoding operation(s), the variation operation comprises at least one of the followings: a sampling variation operation, or, a linear transformation, or an analysis transform operation, and the reconstructed signal \hat{x} is determined according to the varied reconstructed latent representation.

11. The method according to claim 1, wherein the acquiring a bitstream D₀, comprises:
performing an entropy decoding operation on a received bitstream to obtain the bitstream D₀.

12. The method according to claim 11, wherein the method further comprises:
obtaining an optimized parameter;
wherein the performing an entropy decoding operation on a received bitstream to obtain the bitstream D₀, comprises:
performing, according to the optimized parameter, the entropy decoding operation on the received bitstream to obtain the bitstream D₀.

13. An encoding method, comprising:
acquiring an input signal;
performing an analysis transform operation based on the input signal to obtain a latent representation y₀;
performing an encoding operation based on the latent representation y₀ to obtain a feature tensor z₀ by using a neural network; and
generating a bitstream D₀ according to the feature tensor z₀.

14. The method according to claim 13, wherein the method further comprises:
acquiring an encoding information;
wherein the generating a bitstream D₀ according to the feature tensor z₀, comprises:
generating the bitstream D₀ according to the encoding information and the feature tensor z₀, wherein a size of the feature tensor z₀ is larger than a size of the bitstream D₀.

15. The method according to claim 14, wherein the encoding information is signaled with the bitstream D₀.

16. The method according to claim 14, wherein the encoding information is a length tensor N_{bits0}.

17. The method according to claim 16, wherein the length tensor N_{bits0} is obtained by the encoding operation using the neural network.

18. The method according to claim 16, wherein the generating the bitstream D₀ according to the encoding information and the feature tensor z₀, comprises:
determining a mask tensor MSK₀ according to the length tensor N_{bits0} and an index tensor idx₀, wherein the mask tensor MSK₀ comprises X₁ first element(s) with a first value and X₂ second element(s) with a second value, a sum of X₁ and X₂ is the size of the feature tensor z₀, X₁ is a positive integer, X₂ is a positive integer; and
determining the bitstream D₀ according to the mask tensor MSK₀ and the feature tensor z₀, wherein the bitstream D₀ comprises X₁ bit(s), the feature tensor z₀ comprises X₁ third element(s) and X₂ fourth element(s), a location of each elements in the feature tensor z₀ is a same of a location of a corresponding element in the mask tensor MSK₀, a value of each of the X₁ third element(s) is configured to obtain a value of a corresponding bit in the bitstream D₀.

19. The method according to claim 13, wherein the method further comprises:
performing M encoding operation(s) and M decoding operation(s) according to the bitstream Do to obtain M bitstream(s), wherein a m^{th} bitstream among the M bitstream(s) is generated by performing a m^{th} encoding operation among the M encoding operation(s) on an input data INPₘ, and the input data INPₘ is determined according to m reconstructed latent representation(s) obtained according to a first m−1 decoding operation(s) of the M decoding operation(s), m=1, . . . , M.

20. A method for training a neural network, comprising:
acquiring an input signal x;
performing an analysis transform operation based on the input signal to obtain a latent representation y₀;
performing an encoding operation based on the latent representation y₀ to obtain a feature tensor z₀ containing values in the range of 0 to 1 by using a first neural network;
obtaining a reconstructed feature tensor \hat{z}₀ based on the feature tensor z₀;
performing a decoding operation on the reconstructed feature tensor \hat{z}₀ to obtain a reconstructed latent representation ŷ₀ by using a second neural network;
performing a synthesis transform operation based on the reconstructed latent representation ŷ₀ to generate a reconstructed signal \hat{x};
determining a loss function value according to the input signal x and the reconstructed signal \hat{x};
determining a first target neural network according to the first neural network and the loss function value; and
determining a second target neural network according to the second neural network and the loss function value.
